(19) United States
(12) Patent Application Publication
(10) Pub. No.: US 2026/0014504 A1
(43) Pub. Date: Jan. 15, 2026

(54) FILTER DEVICE FOR A GASEOUS MEDIUM, FILTER ELEMENT, USE OF A FILTER ELEMENT, AND METHOD FOR ASSEMBLING A FILTER DEVICE

(71) Applicant: MANN+HUMMEL GmbH, Ludwigsburg (DE)

(72) Inventors: Klaus-Dieter RUHLAND, Meckenheim (DE); Michael KAUFMANN, Meckenheim (DE)

(21) Appl. No.: 19/331,369

(22) Filed: Sep. 17, 2025

Related U.S. Application Data
(63) Continuation of application No. PCT/EP2024/054733, filed on Feb. 26, 2024.

(30) Foreign Application Priority Data
Mar. 23, 2023 (DE) 102023107293.5

(51) Int. Cl. B01D 45/16; B01D 46/00

(52) U.S. Cl. CPC B01D 45/16; B01D 46/0002; B01D 2271/02

(57) ABSTRACT

A filter device for gaseous media has a first filter housing part with a service opening and a filter element receiving space in which a filter element is received through the service opening. A second filter housing part closes off the service opening and is releasably connected of the first housing part. The first housing part has a radially projecting collar with at least one axial contact surface. The filter element has at least one support section projecting radially past a filter medium body thereof and supported on the axial contact surface of the collar. The axial contact surface of the collar has one or more elevations. The support section of the filter element has one or more cutouts corresponding to the elevations and engaging the elevations. The arrangement of the elevations and cutouts provides an unequivocal installation position of the filter element in the first housing part.

### CROSS-REFERENCE TO RELATED APPLICATIONS

This application is a continuation application of international application No. PCT/EP2024/054733 having an international filing date of Feb. 26, 2024, and designating the United States, the international application claiming a priority date of Mar. 23, 2023, based on prior filed German patent application No. 10 2023 107 293.5, the entire contents of the aforesaid international application and of the aforesaid German patent application being incorporated herein by reference.

### BACKGROUND

The invention concerns a filter device for gaseous media, for example air, including a filter housing with at least one inlet opening for gaseous medium to be purified and at least one outlet opening for purified gaseous medium,
wherein at least one filter element, which includes at least one filter medium body, is arranged in the filter housing between the at least one inlet opening and the at least one outlet opening in such a way that it separates a raw side correlated with the at least one inlet opening from a clean side correlated with the at least one outlet opening, wherein the filter housing includes a first housing part at which the outlet opening is arranged and which includes at least one filter element receiving space in which the at least one filter element is arranged,
and wherein the filter housing includes a second housing part at which the at least one inlet opening is arranged and which includes at least parts of at least one cyclone separator,
wherein the second housing part closes off a service opening of the first housing part and the first housing part and the second housing parts are releasably connected to each other and separable from each other in order to be able to remove the at least one filter element through the service opening of the first housing part,
wherein the first housing part includes a radially projecting collar, at least partially circumferentially extending around a virtual axis, which provides, in relation to the axis, at least one axial contact surface at which at least one support section of the filter element, radially projecting in relation to the axis past the filter medium body and circumferentially extending at least partially around the axis, is supported,
and wherein, at the at least one axial contact surface of the radially projecting collar of the first housing part, at least one elevation is arranged which engages in at least one corresponding cutout of the at least one support section of the at least one filter element.

Moreover, the invention concerns a filter element for a filter device for gaseous media, for example air, for example for an air filter device, for example for a filter device according to the invention, including at least one filter medium body,
wherein the filter device includes a filter housing with at least one inlet opening and at least one outlet opening,
wherein the filter element is receivable in the filter housing between the at least one inlet opening and the at least one outlet opening in order to separate a raw side correlated with the at least one inlet opening from a clean side correlated with the at least one outlet opening,
and wherein the filter housing includes a first housing part at which the outlet opening is arranged and which includes a filter element receiving space in which the filter element may be arranged,
and wherein the filter housing includes a second housing part at which the at least one inlet opening is arranged and which includes at least parts of at least one cyclone separator,
wherein the first and the second housing parts are releasably connectable to each other and separable from each other in order to be able to remove the filter element through a service opening of the first housing part, wherein the service opening is closeable by the second housing part,
and wherein the first housing part includes a radially projecting collar, at least partially circumferentially extending around a virtual axis, which provides, in relation to the axis, at least one axial contact surface at which at least one support section of the filter element, radially projecting in relation to the axis past the filter medium body and at least partially circumferentially extending around the axis, may be supported,
and wherein the at least one support surface of the filter element includes at least one cutout in which at least one corresponding elevation present at the axial contact surface of the radially projecting collar of the first housing part may engage.

Furthermore, the invention concerns the use of a filter element, for example of a filter element for gaseous medium, for example of an air filter element, including at least one filter medium body, in a filter device according to the invention, for example in an air filter device, wherein the filter element includes at least one support section, projecting radially in relation to a virtual axis past the filter medium body and at least partially circumferentially extending around the axis, which is supported on at least one contact surface, axial in relation to the axis, of a radially projecting collar of the first housing part which at least partially extends circumferentially around the axis, wherein the at least one support section of the filter element includes at least one cutout in which at least one corresponding elevation engages which is present on the at least one axial contact surface of the radially projecting collar of the first housing part.

In addition, the invention concerns a method for assembly of a filter device for gaseous media, for example of a filter device according to the invention, in which at least one filter element including at least one filter medium body is inserted through a service opening into a filter element receiving space of a first housing part, which includes at least one outlet opening for purified gaseous medium, of a filter housing of the filter device,
wherein the first housing part includes a radially projecting collar extending circumferentially at least partially around a virtual housing axis and providing at least one contact surface axial in relation to the housing axis on which at least one elevation is arranged, and the at least one filter element includes at least one support section, which in relation to a filter element axis projects radially past the at least one filter medium body and at least partially circumferentially extends around the filter element axis and includes at least one cutout,
wherein, upon introduction of the at least one filter element through the service opening, the housing axis and the filter element axis are arranged parallel and the at least one filter element is aligned in relation to the first housing part in relation to the rotational orientation relative to at least one of the axes, which are the housing axis and the filter element axis, in such a way that the at least one elevation of the at least one axial contact surface of the radially projecting collar of the first housing part engages in the at least one corresponding cutout of the support section of the filter element and the at least one circumferentially extending support section of the filter element is supported at the at least one axial contact surface of the projecting collar of the first housing part,
and, subsequently, the service opening is closed by a second housing part of the filter housing which includes at least one inlet opening for gaseous medium to be purified and at least parts of at least one cyclone separator.

WO 2021/005509 A1 discloses an air filter for internal combustion engines which includes a housing with a removable cover in which a chamber is provided that receives a main filter element which is exchangeable and provided with a seal to be arranged between the housing and the cover. The seal includes at least one centering seat or centering projection for receiving a corresponding centering projection or centering seat which is provided at the cover or at the housing when the main filter element is located in the housing and the housing is closed by the cover. The seal includes a plurality of centering seats which are designed such that, when the main filter element is located in the housing and the housing is closed by the cover, they receive respectively a corresponding axial centering projection provided at the housing. Since the centering projections and centering seats of the filter element and of the filter housing which are corresponding to each other are arranged with rotational symmetry, at least two possible mounting positions of the filter element result. This has the disadvantage that, after a removal and reinstallation of the same filter element with deviating rotational orientation in the housing, leaks may occur due to settling effects of the seal.

The invention has the object to provide a filter device, a filter element, the use of a filter element, and a method for assembly of a filter device in which the filter device is improved, for example the filter device is improved in relation to functionality, mounting and/or assembly. For example, the risk of wrong assembly, for example of the wrong installation of the at least one filter element or of the installation of a wrong filter element, is to be reduced.

### SUMMARY

The object is solved according to the invention for the filter device in that an arrangement of the at least one elevation of the at least one axial contact surface of the radially projecting collar of the first housing part and of the at least one corresponding cutout of the at least one support section of the at least one filter element is such that an unequivocal installation position of the at least one filter element in the first housing part results.

According to the invention, the first housing part includes at least one elevation which, in case of proper mounting of the filter element, engages a corresponding cutout of the filter element. The at least one elevation and the at least one corresponding cutout are arranged such that they may correspond only in a single unequivocal installation position, for example rotational orientation in relation to a longitudinal axis, of the filter element in the housing part. The interaction of the at least one elevation with the corresponding cutout prevents that the at least one filter element may be mounted in a different installation position. Furthermore, it may be prevented that a filter element which does not have the required cutout may be installed. As a whole, the risk of wrong mounting in relation to the wrong installation of the at least one filter element as well as in relation to the installation of a wrong, i.e., unsuitable, filter element may be reduced in this way.

“Axial contact surface” means that a relative degree of freedom of movement in relation to the axial direction may be blocked by contact of the circumferentially extending support section of the filter element.

The at least one axial contact surface may extend circumferentially and in radial direction. In this manner, the freedom of movement of the circumferentially extending support section in axial direction may be limited.

The at least one elevation is a structure which protrudes away from the at least one axial contact surface in axial direction. The at least one cutout is a depression in the at least one support section of the filter element.

The filter device and the filter element may be used for example in vehicles, for example motor vehicles, in construction and/or agricultural machines, compressors, in connection with internal combustion engines, in cathode filters, for example in connection with fuel cells.

The gaseous medium which is to be purified may be air. In this case, the filter device may also be referred to as air filter device. With the filter device, liquid or solid particles, for example, dust particles, may be removed from the gaseous medium.

The axis may coincide with a housing axis of the filter housing, an installation/removal axis of the at least one filter element in the first housing part, a connection axis of the first housing part to the second housing part and/or an element axis of the at least one filter element. When in the specification “radial”, “coaxial”, “axial”, “tangential”, “circumferential”, “concentric”, “eccentric” or the like is mentioned, this relates to the axis, if nothing else is mentioned. “Circumferential” relates in this context to a virtual wall surface which surrounds the axis. The axis may be for example a longitudinal axis.

The at least one cyclone separator, for example a cyclone block with a plurality of cyclone separators, may include at least one particle discharge device, for example dust discharge device. In this manner, particles which are separated by the at least one cyclone separator from the gaseous medium to be purified, may be removed from the cyclone separator, for example the cyclone block.

The at least one cyclone separator may be an axial cyclone.

The filter device may include at least one cyclone block which includes a plurality of cyclone separators. In this manner, a larger gas flow may be purified and the available installation space may be optimally utilized.

The at least one inlet opening and the at least one outlet opening may be located, in relation to the axis, at axially opposed sides of the filter housing. In this manner, the filter device as a whole may be of an axial configuration.

The at least one filter medium body may include at least one filter bellows, for example at least one single bellows and/or at least one double bellows. With a filter bellows, the ratio between active filter surface area and required installation space may be improved for the benefit of the filter surface area.

The filter medium body may include a filter medium, for example filter paper, filter nonwoven, filter foam or the like, which is suitable for filtering gaseous medium, for example air. In this manner, the gas to be purified may be purified upon flow through the filter medium.

The filter medium of the at least one filter medium body may be folded or wound. In this manner, the active filter surface area may be enlarged. The filter element may be designed correspondingly as a folded filter element or as a wound element.

The at least one filter element may be a compact filter element, a hollow filter element, a flat filter element or the like.

The filter medium body may include for example a zigzag-shaped folded filter medium with deep folds. In case of an approximately cuboid or prism-shaped filter medium body, one speaks of deep folds for example when a fold height is approximately at least as large as the expansion in direction of the fold edges and/or in direction transverse to the fold edges.

A hollow filter element is characterized in that it includes at least one element interior which is surrounded by filter medium.

The hollow filter element may be a so-called round filter element with a round cross section, an oval round filter element with an oval cross section, a flat oval round filter element with a flattened oval cross section, a conical round filter element in which the round cross section in axial direction tapers in relation to a main axis, a conical oval round filter element in which the oval cross section tapers in axial direction at least in direction of one transverse axis, a conical flat oval round filter element in which the flat oval cross section in axial direction tapers at least in direction of one transverse axis, or a hollow filter element with a different type of cross section, for example an angular one, and/or a different type of axial cross sectional course in direction of an element axis.

The raw side is the side at which the gaseous medium to be purified is located in operation of the filter device. The clean side is the side where the purified gaseous medium is located.

The first housing part includes an at least partially circumferentially extending radially projecting collar which provides at least one axial contact surface at which at least one radially projecting support section of the filter element is supported. In this manner, the circumferentially extending seal may be supported additionally in relation to the axis in axial direction at the first housing part. Here, a further seal region may be realized. In the further seal region, the at least one circumferentially extending seal may act sealingly in axial direction.

The radially projecting collar of the first housing part may extend continuously contiguously, for example circumferentially, or be interrupted.

The projecting collar may include at least two axial contact surfaces, for example four axial contact surfaces, which are located at different axial heights. As an alternative or in addition, the collar may include at least two collar sections, for example four collar sections, with respective contact surfaces which extend partially circumferentially about the axis, respectively. In this manner, a further protection against wrong assembly of the filter device may be realized. For example, in this way a wrong orientation of the at least one filter element, of the first housing part, and of the second housing part may be even more reliably prevented during assembly.

In a further embodiment, a plurality of elevations may be arranged on the at least one axial contact surface of the radially projecting collar of the first housing part and/or a plurality of corresponding cutouts may be arranged in the at least one support section of the filter element. In this manner, the unequivocal installation position may be even more precisely defined. With a plurality of elevations and correlated corresponding cutouts, a redundancy in relation to the unequivocal installation position may be achieved also.

In a further embodiment, the at least one axial contact surface of the radially projecting collar of the first housing part with the at least one elevation may include no rotational symmetry in relation to the axis and/or the at least one support section of the filter element with the at least one cutout may include no rotational symmetry in relation to the axis. In this manner, with the at least one elevation and the at least one corresponding cutout, an unequivocal installation position of the at least one filter element in the first housing part may be realized. The unequivocal installation position is defined by a defined angular position or rotational orientation about the axis.

In a further embodiment, the inner dimensions of the at least one cutout of the at least one filter element may be at least as large as the outer dimensions of the at least one elevation of the first housing part corresponding to the at least one cutout and/or the at least one cutout of the at least one filter element and the correlated corresponding at least one elevation of the first housing part may be complementary. In this manner, the at least one elevation may engage in the correlated corresponding at least one cutout.

“Corresponding” may mean that the at least one cutout of the circumferentially extending support section of the filter element is essentially a negative mold of the corresponding at least one elevation on the axial contact surface of the radially projecting collar. In this case, the at least one cutout and the correlated corresponding at least one elevation are complementary.

A clearance, for example a defined clearance, may remain between the at least one elevation and the corresponding at least one cutout. In this manner, the installation and the removal of the at least one filter element may be simplified because the mounting forces may be reduced. The clearance may be realized, for example, in relation to the axis at the level of the elevation or depth of the corresponding cutout, in relation to the axis in circumferential direction and/or transverse to the circumferential direction.

A clearance fit may be realized between the at least one elevation and the at least one corresponding cutout.

In a further embodiment, on the at least one axial contact surface of the first housing part at least two elevations may be arranged which may differ in their extension in circumferential direction, in their height, and/or in their extension transverse to the circumferential direction, for example in radial direction. As an alternative or in addition, the at least one support section of the at least one filter element may include at least two cutouts which may differ in their extension in circumferential direction, in their height and/or in their extension transverse to the circumferential direction, for example in radial direction. As an alternative or in addition, on the at least one axial contact surface of the first housing part at least two elevations which differ in regard to their shape, dimension and/or orientation may be arranged and the at least one support section of the at least one filter element may include at least two correlated corresponding cutouts relative to the elevations which differ in relation to their shape, dimension and/or orientation. In this manner, a protection from wrong mounting may be further improved.

The at least one elevation and the correlated at least one cutout may be mirror-symmetrically designed in relation to a virtual plane which extends perpendicularly to the virtual axis.

In a further embodiment, the at least one filter element may include, at an inflow side which is facing the second housing part, a seal which circumferentially extends about the virtual axis and which includes a seal section at least partially radially sealingly acting in relation to the axis and circumferentially extending around the axis, wherein a circumferential side of the seal section which is radially outward in relation to the axis rests seal-tightly at an interior wall surface of the first housing part which is radially inward in relation to the axis. In this context, for example a rib, which is projecting away from the second housing part with at least one directional component in axial direction in relation to the axis and circumferentially extending at least partially around the axis, may apply a contact pressure on the circumferential seal in order to press the at least partially radially sealingly acting circumferentially extending seal section against the interior wall surface of the first housing part. In this manner, the filter element receiving space may be sealed in relation to the environment by means of the seal. Furthermore, the raw side of the filter element may be separated from the clean side in this way.

The second housing part may include a circumferential rib with which a contact pressure may be exerted on the circumferential seal when the filter device is assembled. As a result of the contact pressure, an at least partially radially sealingly acting circumferentially extending seal section may be pressed against an interior wall surface of the first housing part.

By means of the seal section acting at least partially in radial direction, it may be achieved that, in the non-clamped state of the first housing part relative to the second housing part, a seal surface of the seal on the part of the at least one filter element includes a clearance, for example a radial gap, in relation to a counterpart surface of the filter housing, namely the interior wall surface of the first housing part. Only by clamping the second housing part to the first housing part, the circumferentially extending seal section is pressed against the interior wall surface of the first housing part. In this way, the sealing action is produced between the first housing part, the second housing part, and the filter element. In addition, a cyclone block which includes the at least one cyclone separator may be sealed axially in relation to the axis by the seal.

As a whole, the configuration of the filter device provides for a simple mounting of the filter element without a force effect in the filter housing. Clamping of the seal may be realized by an axial clamping of the first housing part to the second housing part. For this purpose, a leverage action of suitable closure elements may be utilized.

By means of the seal, an ingress of particles and/or water to the clean side between the at least one filter element and the filter housing may be prevented. In addition, an ingress of particles and/or water into a region between the at least one filter element and the second housing part, for example an immersion tube plate and/or a cyclone block, may be prevented also.

A contact region of the seal section in which the seal section rests radially sealingly acting on the interior wall surface of the first housing part, may be arranged at an axial distance to the at least one axial contact surface of the collar. In this manner, a region may be realized between the seal section and the interior wall surface of the first housing part in which the at least one seal section does not contact the interior wall surface.

The second housing part may be clamped by means of a clamping device to the first housing part. A contact pressure acting at least in axial direction between the first housing part and the second housing part may be realized by means of the clamping device.

The clamping device may be releasable. In this manner, the first housing part and the second housing part may be separated from each other.

The clamping device may include at least one clamping element, for example at least one screw, at least one clamping hook and/or at least one snap hook or the like. In this manner, the clamping device may be simply clamped and released again.

The clamping device may engage directly the second housing part. In this manner, the second housing part may be clamped directly to the first housing part. As an alternative or in addition, the clamping device may engage a cyclone housing and the second housing part may be arranged between the cyclone housing and the first housing part. In this manner, several housing parts may be connected to each other.

The rib may be arranged fixedly, for example fixed in relation to the pressure load, for example stationarily fixed, at the second housing part. In this manner, the rib may be displaced together with the second housing part when axially assembling the first housing part and the second housing part with interposition of the at least one filter element. This would not be possible if the second housing part were part of the at least one filter element. For example, the rib may be displaced together with the second housing part by a clamping action of a clamping device upon assembly.

In a further embodiment, the at least one filter element may include at least one at least partially circumferentially extending frame element which is connected to the at least one filter medium body, wherein for example a surface of the at least partially circumferentially extending frame element is exposed at least in sections, and wherein for example at least an exposed section of the frame element forms at least partially the at least one radially projecting support section of the at least one filter element which is supported at the at least one axial contact surface of the radially projecting collar of the first housing part. In this manner, the at least one support section of the at least one filter element may be connected stably to the filter medium body and a stiff form-fit contact of the filter element at the housing may be realized.

In a further embodiment, the at least one filter element may include at least one circumferential seal which is delimited at an axial end which is facing away from the second housing part by at least one circumferentially extending frame element. In this manner, the at least one seal may be supported at the at least one frame element in axial direction.

The at least one frame element may be connected to the filter medium body. In this manner, the filter medium body may be supported by the at least one frame element.

The at least one frame element, for example a surface of the frame element, may be exposed at least in sections. At the exposed surface, at least one support surface of the at least one filter may be realized. By means of the support surface, a stiff form-fit contact of the filter element at the housing may be realized.

The frame element, for example at least one exposed section of the frame element, may at least partially form a radially projecting support section of the filter element which is supported at an axial contact surface of a radially projecting collar of the first housing part. In this manner, the circumferential seal may be supported even better at its side which is facing away axially from the second housing part.

The at least one frame element may include or be included of plastic material. In this manner, the frame element may be realized robust and with minimal weight. In this case, also the term “plastic frame” may be used for the frame element. As an alternative or in addition, the frame element may include or be included also of at least one other material, for example metal, carbon fibers or a composite material.

The at least one frame element may be part of a skeleton of the filter element and/or may be connected to a skeleton of the at least one filter element. The at least one filter medium body may be held at the skeleton. By means of the skeleton, the at least one filter element may be stabilized and its shape maintained. At least one part of the skeleton may include or be included of plastic material, metal, carbon fibers or a composite material.

The skeleton, for example the skeleton with the at least one frame element, may be realized as one piece. In this manner, the skeleton may be realized particularly stably.

The at least one frame element may also be configured as a component separate from the skeleton in embodiments.

In a further embodiment, the at least one cutout may be formed at a frame element of the at least one filter element. As an alternative or in addition, the at least one cutout may include a contiguous boundary wall, for example the at least one cutout may be designed as a closed pocket. In this manner, a force transmission between the at least one elevation and the filter element may be improved.

The contiguous boundary wall enables a centering of the at least one elevation in the at least one cutout circumferentially and radially in relation to the axis. The boundary wall may surround an opening of the cutout for the correlated corresponding elevation.

A cutout which includes a boundary wall which surrounds the opening and extends to the side opposite the opening may be referred to as a closed pocket.

In a further embodiment, the at least one filter element may include at least one circumferential frame element, wherein the at least one frame element, beginning at the at least one exposed section, may extend at least in sections in axial direction in the direction of the inflow side and/or radially inwardly. As an alternative or in addition, the at least one frame element may be embedded at least in sections by material of the circumferential seal.

The at least one frame element may extend at least in sections in axial direction in the direction of the inflow side and/or radially inwardly. In this manner, a stabilization of the at least one filter medium body may be realized. Furthermore, in this manner a portion of the frame element may serve as a casting mold for material of the seal.

As an alternative or in addition, the at least one frame element at least in sections may be embedded in material of the circumferential seal. In this manner, a support action for the seal may be improved.

In a further embodiment, a rib which is protruding away from the second housing part may support an at least partially radially sealingly acting circumferentially extending seal section of the at least one filter element at a radially inner circumferential side of the seal section, for example at a radially inner circumferential side of the seal section which is radially opposite an interior wall surface of the first housing part. In this manner, the seal section may be pressed by the rib, for example directly, against the interior wall surface of the first housing part.

A contact pressure applied by the rib may include at least one directional component which, in relation to the axis, is oriented radially from the interior to the exterior. In this manner, the corresponding seal section may be directly pressed by the radial sealing force radially outwardly against the interior wall surface of the first housing part. The contact pressure which is applied by the rib may thus provide directly the radial sealing force.

As an alternative or in addition, the contact pressure which is applied by the rib may have a directional component oriented at least parallel to the axis. In this manner, the at least one seal may be compressed in axial direction. The seal material may yield to the compression action radially outwardly and may thus be pressed, radially acting, against the interior wall surface of the first housing part. The contact pressure applied by the rib may thus generate the radial sealing force indirectly, for example by deformation of the seal in transverse direction.

At least the seal section of the circumferential seal may be deformed when the filter housing is mounted with the at least one filter element compared to the non-mounted at least one filter element. The corresponding seal section may thus be pressed flexibly against the interior wall surface of the first housing part.

In a further embodiment, a rib protruding away from the second housing part may contact a seal, surrounding the axis, of the at least one filter element at a free rib rim, axial in relation to the axis, which is facing the second housing part, by means of a directional component, which is acting in axial direction, of the contact pressure. In this manner, the circumferential seal by compression, for example in transverse direction, may be deformed. The deformed seal may thus be pressed, at least partially radially sealingly acting, against the interior wall surface of the housing.

The rib may contact the circumferential seal at an inflow-side end face in axial direction, for example directly, in order to effect a deformation of the circumferential seal and, in this way, press the partially radially sealingly acting circumferentially extending seal section against the interior wall surface of the first housing part.

In a further embodiment, the second housing part may include a protruding rib and the at least one filter element a seal surrounding the axis with at least one seal section, wherein the rib at least in sections may be embodied in a ramp shape. As an alternative or in addition, a contact surface of the rib, which is facing the radially inner circumferential side of the at least partially radially sealingly acting circumferentially extending seal section of the rib, may be positioned at an acute angle in relation to the axis. In this manner, the rib upon axial assembly of the first housing part and of the second housing part may glide along the radially inner circumferential side of the seal section and successively press it against the interior wall surface of the first housing part. Due to the wedge action between “angled” rib and seal section, high radially acting seal pretensioning forces may be achieved with manageable axial mounting forces.

In a further embodiment, the at least one filter element may include a seal surrounding the axis and including at least one seal section, wherein the at least partially radially sealingly acting circumferentially extending seal section may be offset, at least in sections, radially outwardly in relation to an exterior wall surface of the filter medium body, which is radially outward in relation to the axis. As an alternative or in addition, the at least partially radially sealingly acting circumferentially extending seal section may at least in sections axially project past the inflow side of the filter medium body.

In a further embodiment, the filter device may include a cyclone block with a plurality of cyclone separators, wherein the cyclone block includes an immersion tube plate as a second housing part of the filter housing, which includes a plurality of immersion tubes, and a circumferential rib is formed at the immersion tube plate. As an alternative or in addition, the at least one inlet opening may be arranged or formed at the at least one part of the at least one cyclone separator, for example at an immersion tube of the at least one cyclone separator. As an alternative or in addition, the second housing part may include parts of a cyclone block which includes a plurality of cyclone separators. As an alternative or in addition, the second housing part may include or be an immersion tube plate with at least one immersion tube of a cyclone separator. As an alternative or in addition, the second housing part may include a plurality of immersion tubes of corresponding cyclone separators. As an alternative or in addition, the second housing part may be arranged between the first housing part and a cyclone housing of a cyclone block to which the at least one cyclone separator belongs. In this manner, the filter device may be designed in a compact configuration with at least one filter element and at least one cyclone block. By means of the cyclone block with a plurality of cyclone separators, an efficient pre-separation of particles from the gaseous medium to be purified may be realized and the installation size requirement for the pre-separation may be minimized.

In a further embodiment, the second housing part may include a protruding rib and the at least one filter element a seal surrounding the axis with at least one seal section, wherein an inflow-side axial end of the circumferential seal, viewed in a direction axial to the axis, may project past a free end of the rib of the second housing part. As an alternative or in addition, the rib, viewed in the direction axial to the axis, may project past a free end of the circumferential seal, for example of the at least one seal section. As an alternative or in addition, the rib may dip into a depression of the circumferential seal which is open at its side which is axially facing the inflow side in relation to the axis. As an alternative or in addition, the second housing part may include at least one immersion tube of at least one cyclone separator which, at its side which is facing the inflow side of the at least one filter element, includes an outflow end which is at least in sections surrounded by an immersion tube rim section, wherein the immersion tube rim section may be located, when the filter device is assembled, at an axial distance to the free end of the circumferential seal radially inside of the seal section.

In this manner, an axial overlap between the seal and the second housing part, for example the rib and/or the immersion tubes, may be realized.

The immersion tube rim section, when the filter device is assembled, may be located at an axial distance to the free end of the seal radially inside of the seal section. The outflow end, viewed axially, may be located beyond the inflow-side axial free end of the circumferential seal. The immersion tube rim section which surrounds the outflow end at least in sections, and thus also the outflow end of the at least one immersion tube, may dip, viewed axially, behind the free end of the circumferential seal and thus behind the inflow-side end of the at least one filter element.

In a further embodiment, the second housing part may include a protruding rib and the at least one filter element a seal surrounding the axis with at least one seal section, wherein the first housing part and the second housing part form a seal chamber in which the at least partially radially acting circumferentially extending seal section is received, wherein the seal chamber is delimited radially inwardly by the rib of the second housing part, radially outwardly by the interior wall surface of the first housing part, and axially by a collar connected to the second housing part, for example by a collar of a further part which is connected to the second housing part. In this manner, a space is created within which the seal section may be accommodated even after a deformation.

The collar may provide an axial seal surface at which the circumferential seal rests acting sealingly in axial direction. In this manner, a sealing action in outward direction, for example to the environment, is made possible.

The seal chamber may be delimited at the inflow side axially by a collar which is connected to the second housing part, for example by a collar of a further part which is connected to the second housing part.

In a further embodiment, the second housing part may include a protruding rib and the at least one filter element a seal surrounding the axis with at least one seal section, wherein in a state of the filter device in which the at least one filter element is arranged in the at least one filter element receiving space and the second housing part is released from the first housing part, a radial gap is present between the interior wall surface of the first housing part and the radially outer circumferential side of the at least partially radially sealingly acting circumferentially extending seal section. In this manner, the at least one filter element may be moved in axial direction into the filter element receiving space or out of the latter without the radially sealingly acting circumferentially extending seal section rubbing against the interior wall surface of the first housing part, whereby the mounting forces may be minimized.

In a further embodiment, the first housing part, for example the radially projecting collar, may include a collar wall surrounding the axis which surrounds the service opening and which projects past the axial contact surface of the radially projecting collar at the side which is axially facing away from the filter element receiving space.

The collar wall may surround radially outwardly the axial contact surface of the radially projecting collar of the first housing part and the at least one elevation.

The axial contact surface of the radially projecting collar of the first housing part at which the at least one elevation is present may be axially offset in relation to a plane in which the service opening is positioned. In this manner, the axial contact surface and the at least one elevation may be protected by corresponding sections of the radially projecting collar in relation to the environment.

“Axially offset”, viewed from the inflow side in axial direction, may mean axially remote.

An interior wall surface of the first housing part at which an at least partially radially acting circumferentially extending seal section of a circumferential seal may rest may be present immediately adjacent to the axial contact surface. In this manner, the sealing action may be realized in the vicinity of the service opening.

An inflow-side free rim of a collar wall with an interior wall surface of the first housing part, at which an at least partially radially sealingly acting seal section surrounding the axis of a seal surrounding the axis may rest, may be positioned axially adjacent to, for example in the same plane, as the service opening. In this manner, the service opening may be realized in the region of the free rim of the collar wall.

In a further embodiment, the filter medium body may have a cross-sectional shape which includes at least two curved sides connected by two for example straight sides. As an alternative or in addition, the filter medium body may include a radially outer filter medium section and a radially inner filter medium section which in relation to the axis are circumferentially contiguous, respectively, wherein the radially inner filter medium section is arranged within the radially outer filter medium section. As an alternative or in addition, an outer wall of the filter medium body, for example of a radially outer filter medium section of the filter medium body, may have an elongate oval cross section. As an alternative or in addition, an inner wall of the filter medium body, for example of a radially inner filter medium section of the filter medium body, may include an elongate oval cross section. As an alternative or in addition, an outer wall of the filter medium body, for example of a radially outer filter medium section of the filter medium body, viewed from the inflow side in direction of the axis, may taper, for example conically taper. As an alternative or in addition, the interior wall surface of the filter medium body, for example of a radially inner filter medium section of the filter medium body, viewed from the outflow side in the direction of the axis, may taper, for example taper conically. In this manner, a filter element may be realized which includes an improved ratio between space requirement and filter surface area for the benefit of the filter surface area.

At least one filter medium section may be realized as a filter bellows. In case of a filter bellows, the filter medium may be folded. In this manner, an enlargement of the active filter surface area may be achieved.

In a further embodiment, at least one filter medium section of the filter medium body, for example a radially outer filter medium section of the filter medium body, may be flowed through radially from the interior to the exterior. As an alternative or in addition, at least one filter medium section of the filter medium body, for example a radially inner filter medium section of the filter medium body, may be flowed through radially from the exterior to the interior. In this manner, a ratio between axial expansion and radial expansion of the filter element may be improved.

In a further embodiment, the at least one filter medium body may include at least two filter bellows, for example in inner filter bellows and an outer filter bellows, for example at least two folded filter bellows which at least partially surround the axis and which may be flowed through in parallel by the gaseous medium to be purified. As an alternative or in addition, an inner filter bellows of the at least one filter medium body may be arranged in an interior enclosed by an outer filter bellows of the at least one filter medium body. As an alternative or in addition, the at least one filter medium body may include at least one filter bellows, for example an inner filter bellows and/or an outer filter bellows which includes a slant in relation to the axis. By the use of a plurality of filter bellows and their particular arrangement relative to each other, the ratio of space requirement in relation to the active filter surface area to be flowed through may be improved as a whole for the benefit of the filter surface area.

“To be flowed through in parallel” means that the filter bellows are arranged operationally, for example in relation to the flow of the gaseous medium, in a parallel acting manner. This does not mean that the filter bellows are arranged parallel in the geometric sense. The filter bellows are flowed through operationally in parallel by the gaseous medium to be purified. In contrast thereto, in a serial arrangement of the filter bellows, they are flowed through one after another, i.e., serially.

The filter device may include at least one further filter element, for example a secondary filter element, which fluidally is arranged downstream of the at least one filter element, for example the filter element, for example a main filter element, including the at least one support section. In this manner, the separation of particles from the gaseous medium to be purified may be further improved and, as an alternative or in addition, an ingress of contaminations to a clean side during servicing of the main filter element may be avoided.

The at least one further filter element, for example the secondary filter element, may be arranged in the filter element receiving space spatially between the filter element with the at least one support section and the at least one outlet opening of the filter housing. In this manner, the filter device may be constructed in a more compact configuration.

Furthermore, the object is solved according to the invention for the filter element in that an arrangement of the at least one cutout of the at least one circumferential support section of the filter element is such that, in a mounted state in which the at least one corresponding elevation at the at least one axial contact surface of the radially projecting collar of the first housing part engages therein, an unequivocal installation position of the filter element in the first housing part results.

According to the invention, a filter element is realized which by means of at least one particularly arranged cutout in combination with at least one corresponding elevation on the part of the first housing part enables an unequivocal installation in the first housing part. In this way, at the latest upon assembly of the filter device it may be recognized whether the correct filter element with the required at least one cutout is used. Furthermore, the filter element must be oriented such that the at least one cutout corresponds with the corresponding elevation on the part of the first housing part. As a whole, the risk of false or erroneous mounting may be significantly decreased in this way.

Furthermore, the object is solved according to the invention in respect to the use in that an arrangement of the at least one elevation on the at least one axial contact surface of the radially projecting collar of the first housing part and of the at least one corresponding cutout of the at least one support section of the at least one filter element is such that an unequivocal installation position of the at least one filter element in the first housing part results.

In addition, the object is solved according to the invention for the method in that by means of the arrangement of the at least one elevation on the at least one axial contact surface of the radially projecting collar of the first housing part and of the at least one corresponding cutout of the at least one support section of the at least one filter element, the at least one filter element is arranged in an unequivocal installation position in the first housing part.

According to the invention, the at least one filter element is introduced in a simple and unequivocal manner into the filter housing.

The installation of the filter element in the filter element receiving space of the first housing part and the attachment of the second housing part to the first housing part may be carried out in axial direction in relation to at least one of the axes which are the housing axis and the filter element axis.

Clamping of the circumferential seal may be realized by means of clamping means which engage between the first housing part and the second housing part.

In other respects, the features and advantages which have been disclosed in connection with the filter device according to the invention, the filter element according to the invention, the use according to the invention, and the method according to the invention and their respective embodiments apply among each other and vice versa. The individual features and advantages can, of course, be combined among each other, wherein further advantageous effects may result which go beyond the sum of the individual effects.

### BRIEF DESCRIPTION OF THE DRAWINGS

Further advantages, features and details of the invention result from the following description in which embodiments of the invention will be explained in more detail with the aid of the drawing. A person of skill in the art will consider the features disclosed in combination in the drawing, the description, and the claims expediently also individually and combine them to expedient further combinations.

FIG. 1 shows an isometric illustration of a filter device for gaseous media according to a first embodiment, comprising a cyclone block, viewing the side of an outlet socket.

FIG. 2 shows a longitudinal section through the filter device of FIG. 1.

FIG. 3 shows a detail view of a main filter element of the filter device of FIGS. 1 and 2 in the region of a circumferential seal.

FIG. 4 shows a detail view of a longitudinal section of a housing pot of the filter device of FIGS. 1 and 2 in the region of a collar of the housing pot surrounding a service opening.

FIG. 5 shows an isometric illustration of a skeleton of a main filter element of the filter device of FIGS. 1 and 2 with a viewing direction of the inflow side of the main filter element.

FIG. 6 shows a detail view of a longitudinal section of an immersion tube plate of the cyclone block of the filter device of FIGS. 1 and 2.

FIG. 7 shows a detail view of the longitudinal section through the filter device of FIG. 2 in the region of a connection of the housing pot and of the cyclone block.

FIG. 8 shows an isometric illustration of a housing pot of a filter device for gaseous media according to a second embodiment.

FIG. 9 shows an axial view of the housing pot of FIG. 8 viewed in the direction of a service opening.

FIG. 10 shows an isometric illustration of a main filter element for installation in the housing pot of FIGS. 8 and 9 of the filter device according to the second embodiment.

FIG. 11 shows an axial view of the main filter element of FIG. 10 viewed in the direction of the outflow side.

In the drawing figures same components are provided with same reference characters.

### DETAILED DESCRIPTION

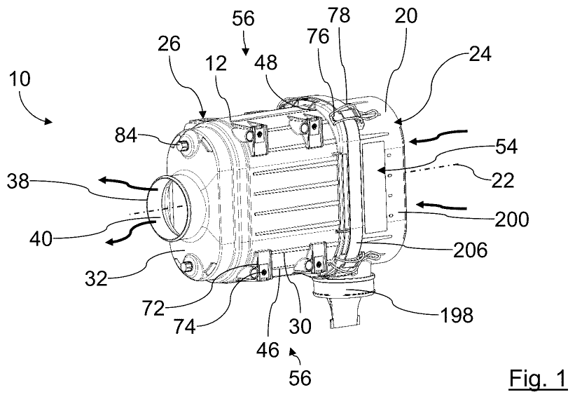

In FIGS. 1 to 7, a filter device 10 according to a first embodiment for gaseous media and its components are shown in different illustrations. Gaseous media, for example, air, may be freed from solid particles, for example, dust, by means of the filter device 10.

The filter device 10 may be used in vehicles, for example, motor vehicles, in construction and/or agricultural machines, compressors in connection with internal combustion engines, in cathode filters, for example, in connection with fuel cells, or the like.

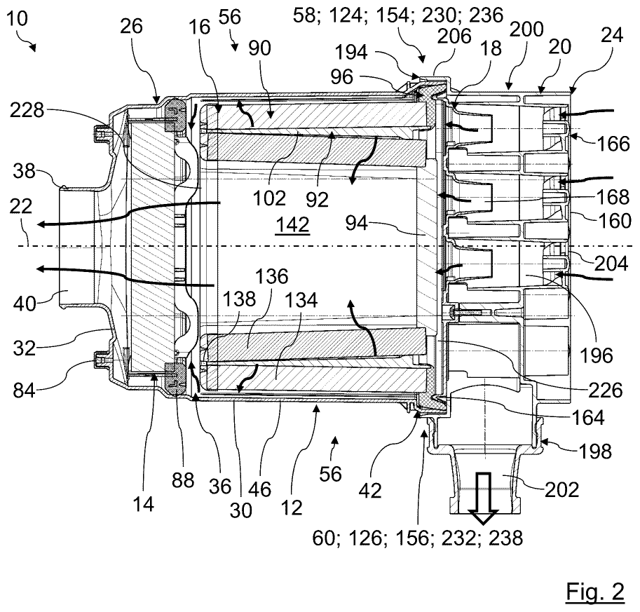

The filter device 10 comprises, as shown in an exploded illustration in FIG. 2, for example, a housing pot 12, an after filter element 14, a main filter element 16, an immersion tube plate 18, and a cyclone housing 20. The filter device 10 as a whole may be axially constructed in relation to an axis 22.

In the following, the components of the filter device 10 and their arrangement relative to each other in relation to the virtual axis 22 will be explained. The axis 22 may coincide with a housing axis of the housing pot 12, an installation/removal axis of the after filter element 14 and of the main filter element 16 in the housing pot 12 or out of the housing pot 12, a connection axis of the immersion tube plate 18 to the housing pot 12, a connection axis of the cyclone housing 20 to the immersion tube plate 18, a connection axis of the cyclone housing 20 to the housing pot 12, an element axis of the after filter element 14, an element axis of the main filter element 16, a housing axis of the housing pot 12, a plate axis of the immersion tube plate 18, and/or a housing axis of the cyclone housing 20. When in the specification “radial”, “coaxial”, “axial”, “tangential”, “circumferential”, “concentric”, “eccentric” or the like is mentioned, this relates to the axis 22, if nothing else is mentioned. In this context, “circumferential” relates to the course of respective virtual wall surfaces which surround the axis 22.

In the connected state, the immersion tube plate 18 and the cyclone housing 20 may form a cyclone block 24. On the other hand, the housing pot 12 as a first housing part and the immersion tube plate 18 as a second housing part may form a filter housing 26 in the connected state. When the filter device 10 is assembled, the immersion tube plate 18 may be connected to the cyclone housing 20 by means of screws, for example.

In the following, the housing pot 12 will be explained in more detail.

The housing pot 12 may be realized as one piece. The housing pot 12 may be comprised, for example, of plastic material, for example, a hard plastic material.

The housing pot 12 comprises a housing wall 30 which contiguously surrounds the axis 22. At an axial end face of the housing pot 12, a housing bottom 32 adjoins the housing wall 30. At the side which is axially facing away from the housing bottom 32, the housing wall 30 surrounds a service opening 34.

The housing wall 30 and the housing bottom 32 delimit a filter element receiving space 36 of the housing pot 12. The after filter element 14 and the main filter element 16 may be arranged in the filter element receiving space 36, when the filter device 10 is assembled. In this context, the after filter element 14 and the main filter element 16 may be inserted into the filter element receiving space 36 and removed therefrom through the service opening 34.

An outlet socket 38 may be integrated into the housing bottom 32. The outlet socket 38 comprises an outlet opening 40 for purified gaseous medium. The outlet socket 38 extends, for example, axially to the axis 22. For example, the outlet socket 38 has a circular cylindrical shape at least in sections.

In the region axially adjacent to the housing bottom 32, at the side which is axially facing the service opening 34, the housing wall 30 may be stepped twice radially outwardly. As a whole, the housing pot 12 thus tapers in axial direction toward the housing bottom 32. The stepped region forms a receiving region for the after filter element 14. The region of the filter element receiving space 36 located between the stepped region and the service opening 34 serves for receiving the main filter element 16.

Viewed perpendicularly to the axis 22, the housing wall 30 has an elongate oval cross section.

At the axial side with the service opening 34, the housing wall 30 comprises a collar 42 which surrounds the axis 22 contiguously.

Viewed in axial direction, the collar 42 comprises an elongate oval cross section. The elongate oval cross section of the collar 42 differs however from the elongate oval cross section of the housing wall 30 between the collar 42 and the housing bottom 32. The housing wall 30 may be symmetrical in relation to a rotation around the axis 22 by 180° in the region between the housing bottom 32 and the collar 42. In contrast thereto, the collar wall 44 comprises no rotational symmetries in relation to the axis 22. This will be explained further in more detail in the following.

The collar wall 44 may be radially outwardly offset in relation to a main wall section 46 of the housing wall 30. The main wall section 46 extends in axial direction between the collar 42 and the housing bottom 32.

A collar 48 extends between the main wall section 46 and the collar wall 44.

At its axially oriented inner side which faces away from the filter element receiving space 36, the collar 48 comprises a plurality of contact surfaces 50. The contact surfaces 50 may be arranged circumferentially distributed along the collar 48 in respective collar sections of the collar 42. For ease of differentiation, in the following the reference characters of the contact surfaces 50 may be provided with the indices A, B, C or D, i.e., 50A, 50B, 50C or 50D, wherein the contact surface 50B is not shown in the drawing figures.

A ramp surface 52 may be arranged between the contact surface 50A and the contact surface 50D. A further ramp surface 52 may be arranged at the radially opposed side between the contact surface 50C and the contact surface 50D. The two ramp surfaces 52 may be arranged on radially opposed sides.

The contact surfaces 50 extend in circumferential direction and perpendicularly to the axis 22. The ramp surfaces 52 extend circumferentially and may be slanted in relation to the axis 22 in axial direction toward the axis 22, viewed from the service opening 34.

The ramp surfaces 52 of the collar 42 extend along long sides 54 of the filter device 10 which may be elongate oval as a whole, viewed in axial direction. Short sides 56 extend between the respective long sides 54.

In the following, the identifiers long sides 54 and short sides 56 may be used for improved clarity for the components of the filter device 10 which have an elongate oval cross section.

A flatly curved section 58 extends at one of the short sides 56 of the collar wall 44. A circularly curved section 60 of the collar wall 44 extends at the short side 56 which may be opposed in relation to the axis 22. The flatly curved section 58 has a larger radius of curvature than the circularly curved section 60. Between the flatly curved section 58 and the circularly curved section 60, a straight connection section 62 of the collar wall 44 extends along the long sides 54, respectively.

In the region of the flatly curved section 58, the three contact surfaces 50A, 50B and 50C are provided. The fourth contact surface 50D may be located at the side of the circularly curved section 60. The two lateral contact surfaces 50A and 50C extend respectively from the transition of the respective straight connection section 62 into the flatly curved section 58 to the third contact surface 50B. The third contact surface 50B extends between the lateral contact surfaces 50A 50C.

The middle contact surface 50B on the part of the flatly curved section 58 and the contact surface 50D on the part of the circularly curved section 60 may be positioned at the same axial height. The contact surfaces 50A, 50B and 50C on the part of the flatly curved section 58 are located, as may be seen in FIG. 4, for example, at different axial levels. The middle contact surface 50B and the contact surface 50D are located, viewed in axial direction, closer to the free rim of the collar wall 44 than the two outer contact surfaces 50A and 50C. An axial distance 64 between the contact surface 50D and the contact surface 50C may be smaller than an axial distance 66 between the contact surface 50D and the contact surface 50A.

The contact surface 50D extends circumferentially at the center of the circularly curved section 60 on the part of the circularly curved section 60 approximately around a circumferential angle of approximately 90° around a circle center, not shown, of the circularly curved section 60.

Between the contact surface 50D and each one of the neighboring ramp surfaces 52, there may be a depression 68, respectively. The depressions 68 extend in axial direction, radial direction, and along the collar wall 44, respectively. The ramp surfaces 52 extend along the collar wall 44 from the respective straight connection sections 62 all the way to the respective circularly curved sections 60.

A first elevation 248A may be arranged on the first outer axial contact surface 50A in the flatly curved contact section 58 of the radially projecting collar 42 of the housing pot 12. A second elevation 248C may be arranged on the axial contact surface 50C in the flatly curved contact section 58. The elevations 284A and 284C may be each structures projecting in axial direction away from the corresponding contact surfaces 50.

The first elevation 248A on the first outer axial contact surface 50A and the second elevation 284C on the second outer axial contact surface 50C of the housing pot 12 may be different in relation to their shape, dimension and/or orientation. The first elevation 248A on the first outer axial contact surface 50A and the second elevation 248C on the second outer axial contact surface 50C differ in their extension in circumferential direction and/or their radial width. The axial contact surfaces 50 of the radially projecting collar 42 of the housing pot 12 with the elevations 248 exhibit no rotational symmetry in relation to the axis 22.

In the main wall section 46 of the housing wall 30, a plurality of grooves 70 extend approximately axially from the collar 48 to a point shortly before the stepped region of the housing wall 30, respectively. The grooves 70 may be arranged, circumferentially distributed, along the main wall section 46. The grooves 70 may be each realized as bulges in radially outward direction in the main wall section 46. Each groove 70 forms an elongate recess at the radially inner side of the main wall section 46. In addition, each one of the grooves 70 forms an elongate protrusion at the radially outer side of the main wall section 46. Depending on the circumferential position, the grooves 70 open toward the contact surfaces 50 or toward the ramp surfaces 52. Viewed in axial direction, the cross sections of the grooves 70 taper toward the housing bottom 32, respectively.

Furthermore, at the radially outer side of the main wall section 46, a total of eight fastening blocks 72 may be arranged. Four of the fastening blocks 72 are located in this context at the side of the main wall section 46 which may be axially facing the collar 42. The four other fastening blocks 72 are located at the side which may be axially facing the stepped region adjacent to the housing bottom 32. At each one of the fastening blocks 72, a screw collar 74 may be arranged at the side which may be facing the corresponding long side 54. The screw collars 74 are realized as flat regions, for example. The screw collars 74 at a common long side 54 extend in a plane. Each of the screw collars 74 may comprise a threaded hole. The axes of the threaded holes of the screw collars 74 may extend parallel to each other. By means of the screw collars 74, the filter device 10 may be fastened to corresponding holding elements. The holding elements may be, for example, connected fixedly to the machine in which the filter device 10 is to be used.

Furthermore, a total of four clamping noses 76 may be arranged at the outer side of the collar 48 which may be axially facing away from the collar wall 44. The clamping noses 76 may be projecting in axial prolongation of the collar wall 44 away from the collar wall 44. Two of the clamping noses 76 may be located in the region of the flatly curved section 58 in the vicinity of the transitions of the flatly curved section 58 to the respective neighboring straight connection sections 62. The two other clamping noses 76 may be located in the region of the circularly curved section 60 in the vicinity of the transitions to the respective neighboring straight connection section 62. Viewed in axial direction, the clamping noses 76 may be aligned with the axially neighboring fastening blocks 72, respectively. The clamping noses 76 serve to be engaged by respective clamping clips 78. The clamping clips 78, as will be explained in more detail in the following, may be supported at the cyclone housing 20.

Between the collar 48 and the free rim of the collar wall 44, the collar wall 44 comprises at the radially inner circumferential side an interior wall surface 86 extending in circumferential direction. At the side which is axially facing the free rim of the collar wall 44, the interior wall surface 86 comprises a ramp section 80. In the ramp section 80, the interior wall surface 86 extends at a slant to the axis 22. The radially inner circumference of the collar wall 44 increases in the ramp section 80 in axial direction toward the free rim. The ramp section 80 forms thus a funnel-shaped insertion aid for the after filter element 14 and the main filter element 16. Axially between the ramp section 80 and the collar 48, the interior wall surface 86 extends parallel to the axis 22.

At the outer side of the housing bottom 32 which is facing away axially from the filter element receiving space 36, two nipples 84 may be furthermore arranged. The nipples extend parallel to the axis 22, respectively. The nipples 84 may be located on radially opposed sides of the axis 22 adjacent to the short sides 56 of the housing pot 12, respectively.

The after filter element 14 may be designed, for example, as a so-called flat filter element. The after filter element 14 serves as a secondary filter element. Viewed in the direction of the axis 22, the radially outer side of the after filter element 14 has an elongate oval shape. The course of the radially outer wall surface of the after filter element 14 corresponds to the elongate oval shape of the radially inner circumferential side of the housing pot 12 in the twice stepped region adjacent to the housing bottom 32. At one of its axial end faces, the after filter element 14 has a seal 88 extending circumferentially in relation to the axis 22. By means of the seal 88, the clean side of the after filter element 14 may be separated from the raw side in the installed state.

In the following, the main filter element 16 will be explained in more detail.

The main filter element 16 comprises a filter medium body 90, a skeleton 92, an end member 94, and a seal 96.

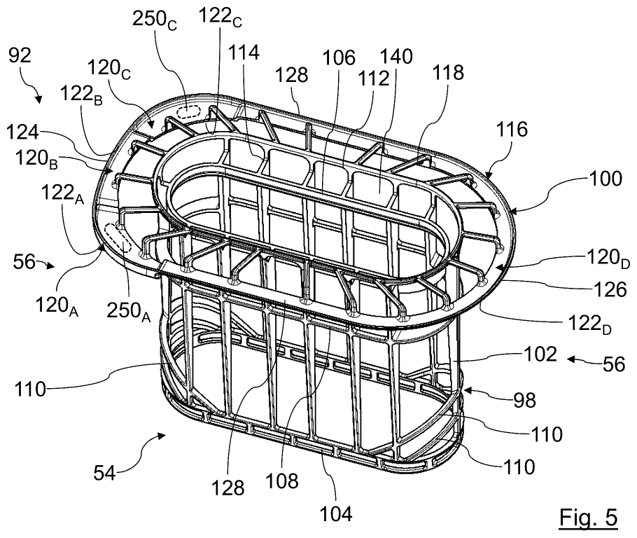

The skeleton 92 is shown in detail in the FIG. 5. The skeleton 92 as a whole may be realized as one piece. For example, the skeleton 92 may be manufactured as an injection molded part of hard plastic material.

The skeleton 92 may comprise a central element 98 and a frame element 100.

The central element 98 may serve as a support element at which filter bellows 134 and 136, which will be explained in more detail in the following, may be supported. The central element 98 comprises a plurality of axial stays 102. The axial stays 102 extend each approximately parallel to the axis 22. The axial stays 102 may be arranged distributed around the axis 22. At an axial side of the skeleton 92, the ends of the axial stays 102 located there may be connected to each other by a connection ring 104.

Viewed in axial direction, the axial stays 102 have an approximately rectangular cross section. The long sides of the rectangular cross section of each axial stay 102 may be aligned respectively parallel to a radial direction in relation to the axis 22. The circumferential dimensions of the axial stays 102 in relation to the axis 22, i.e., the expansion of the short sides of the rectangular cross section of the axial stays 102, may be constant across their axial length. The radial dimensions of the axial stays 102 in relation to the axis 22, i.e., the expansion of the long sides of the rectangular cross section of the axial stays 102, increases from the end facing the connection ring 104, viewed in axial direction. As a whole, the axial stays 102 may be designed approximately in a wedge shape, viewed in circumferential direction in relation to the axis 22.

The radially outer sides of the axial stays 102 in relation to the axis 22 may be slanted toward the axis 22, viewed from the frame element 100 toward the connection ring 104. Thus, a virtual radially outer wall surface surrounding the central element 98 and defined by the radially outer sides of the axial stays 102 comprises a conical shape tapering toward the connection ring 104. The virtual radially inner wall surface which is defined by the axial stays 102 comprises a shape tapering from the connection ring 104 toward the frame 100, viewed axially.

The connection ring 104 has an elongate oval cross section viewed in axial direction. The connection ring 104 comprises two parallel extending coaxial ring sections of the same circumference which may be connected to each other by axially extending stays.

The ends of the axial stays 102 which are axially opposed to the connection ring 104 may be connected to a radially inner ring 106. The radially inner ring 106 extends, on the one hand, parallel and, on the other hand, coaxially to the connection ring 104. The radially inner ring 106 extends between the radially inner circumferential sides of the ends of the axial stays 102.

Between the radially inner ring 106 and the connection ring 104, an intermediate ring 108 may be arranged. The intermediate ring 108 connects the axial stays 102 to each other. The intermediate ring 108 extends, on the one hand, parallel and, on the other hand, coaxially to the connection ring 104 and to the radially inner ring 106. The intermediate ring 108 extends in radial expansion from the radially inner circumferential sides of the axial stays 102 to the radially outer circumferential sides. The intermediate ring 108 may be positioned at an axial distance to the radially inner ring 106 which corresponds to approximately a third of the axial distance between the radially inner ring 106 and the connection ring 104.

Two connection arcs 110 extend at the short sides 56, respectively. Each one of the connection arcs 110 may be connected with its free ends to the connection ring 104. In the curved center, each one of the connection arcs 110 may be connected to a central axial stay 102. The connection arcs 110 each extend from the connection ring 104 at the side which may be axially facing the frame element 100 at a slant to the axis 22 in the direction toward the central axial stay 102. At each short side 56, one of the connection arcs 110 may be connected, at an axial distance in relation to the connection ring 104, to the central axial stay 102, which distance approximately amounts to about one fifth of the axial distance between the frame element 100 and the connection ring 104. This connection arc 110 connects the connection ring 104 to the central axial stay 102. The other connection arc 110 at the short side 56 may be connected, at an axial distance in relation to the connection ring 104, to the central axial stay 102, which distance corresponds to approximately one fourth of the axial distance between the frame element 100 and connection ring 104. The latter connection arc 110 connects the connection ring 104 to the central axial stay 102 and the two axial stays 102 neighboring the central axial stay 102 at the short sides 56.

At their wide end in radial direction, the axial stays 102 comprise at the radially outer side a step which rises in axial direction. The steps of the axial stays 102 are connected to an outer ring 112.

The radially outer ring 112 has an elongate oval cross section. The radially outer ring 112 extends coaxially to the axis 22. The radially outer ring 112 may be axially spaced apart from the radially inner ring 106. This may be achieved by the steps.

At the ends of the axial stays 102, respective connection openings 114 may be realized between the outer ring 112 and the radially inner ring 106. The connection openings 114 comprise the axial height of the steps at the ends of the axial stays 102. By means of the connection openings 114, axially extending flow spaces 140 which may be located between two neighboring axial stays 102 may be connected to each other at the level of the radially inner ring 106.

The radially outer ring 112 may be surrounded by a support ring 116 of the frame element 100. The support ring 116 extends coaxially to the axis 22. The support ring 116 comprises an elongate oval cross section which differs from the elongate oval cross section of the radially outer ring 112, of the radially inner ring 106, and of the connection ring 104, as will be explained in more detail in the following.

The support ring 116 may be connected by means of radially extending radial stays 118 to the radially outer ring 112. The radial stays 118 comprise at their side which may be facing the support ring 116 a bend by approximately 90°, respectively, in the direction toward the connection ring 104. The ends of the radial stays 118 behind the bend engage respectively at the side of the support ring 116 which is axially facing away from the connection ring 104.

The support ring 116 comprises four support sections 120. The reference characters of the support sections 120 are identified with the indices A, B, C, and D for better differentiation.

The sides of the support sections 120 axially facing the connection ring 104 form each a support surface 122. The reference characters of the support surfaces 122, like the reference characters of the respective support sections 120, are provided with the indices A, B, C, and D for better differentiation. The support surfaces 122 each may be planar. The planes of the support surfaces 122 extend perpendicularly to the axis 22, respectively.

In the first outer support section 120A of the support ring 116 of the frame element 100 of the skeleton 92 of the main filter element 16, a first cutout 250A corresponding to the first elevation 248A on the first outer axial contact surface 50A is arranged. In the second outer support section 120C of the support ring 116 of the skeleton 92 of the frame element 100, a second cutout 250C corresponding to the second elevation 248C of the second outer axial contact surface 50C is arranged.

The cutouts 250A and 250C each may be a recess in the corresponding support section 120 of the main filter element 16. The cutouts 250A and 250C each may be designed as a closed pocket. The cutouts 250A and 250C each have a contiguous boundary wall. The contiguous boundary wall enables a centering of the corresponding elevation 248 in the cutout 250 in relation to the axis 22 circumferentially and radially. The boundary wall surrounds an opening of the cutout 250 for the correlated corresponding elevation 248. Moreover, the respective boundary wall extends to the side which is radially opposite the opening. In this way, the boundary wall closes the side of the cutout 250 which is opposed to the opening for the corresponding elevation 248.

The first cutout 250A of the main filter element 16 in the first outer support section 120A and the second cutout 250C in the second outer support section 120C may be different. The first cutout 250A in the first outer support section 120A and the second cutout 250C in the second outer support section 120C differ from each other in their extension in circumferential direction and in their radial width.

The inner dimensions of the cutouts 250 of the main filter element 16 may be as large as the outer dimensions of the elevations 248 of the housing pot 12 corresponding to the respective cutouts 250. The cutouts 250 of the main filter element 16 and the correlated corresponding elevations 248 of the housing pot 12 may be complementary. The support sections 120 of the main filter element 16 with the cutouts 250A and 250C may each have as a whole no rotational symmetry in relation to the axis 22. In the mounted state in which the main filter element 16 is mounted in the housing pot 12, elevations 248 and the correlated corresponding cutouts 250 are mirror-symmetrically designed in relation to a virtual plane extending perpendicularly to the virtual axis 22.

As a whole, the frame element 100 beginning at the support sections 120 may extend radially inwardly and in the direction toward an inflow side 226 of the main filter element 16.

The cross section of the radially outer circumferential side of the support ring 116 may correspond in its shape to the cross section of the radial inner circumferential side of the collar wall 44 of the housing pot 12. The radially outer circumference of the support ring 116 may be somewhat smaller than the radially inner circumference of the collar wall 44.

The support ring 116 may comprise a flatly curved section 124 at the radially outer wall surface and a circularly curved section 126. The flatly curved section 124 and the circularly curved section 126 are connected to each other by two opposed straight connection sections 128. The radius of curvature of the flatly curved section 124 may be larger than the radius of curvature of the circularly curved section 126. As a whole, thus the support ring 116 and therefore also the radially outer wall side of the frame element 100 has no rotational symmetry in relation to the axis 22.

The central support section 120B with the central support surface 122B extends at the center of the flatly curved section 124 between the two outer support sections 120A and 120C with the corresponding outer support surfaces 122A and 122C. The support sections 120A and 120C with their respective support surfaces 122A and 122C extend between the respective straight connection sections 128. The circumferential extension of the two lateral support sections 120A and 120C corresponds to the circumferential extension of the two lateral contact surfaces 50A and 50C of the housing pot 12.

The support section 120D with its support surface 122D extends at the side radially opposed to the central support section 120B centrally in the circularly curved section 126. The circumferential extension of the support section 120D and of the support surface 122D may be larger than the circumferential extension of the contact surface 50D of the housing pot 12.

The support section 120D with the support surface 122D may pass without a step into the respective neighboring straight connection sections 128 of the support ring 116.

The central support surface 122B and the central support surface 122D may be located at the same axial height. The outer support surface 122A may be located at the side of the support ring 116 facing the connection ring 104 at an axial distance in relation to the central support surface 122B. The other outer support surface 122C may be located at the side of the support ring 116 facing the connection ring 104 at an axial distance in relation to the central support surface 122B. The distance of the outer support surface 122A may be larger than the distance of the outer support surface 122C. The distance of the outer support surface 122A corresponds to the distance 66 of the outer contact surface 50A of the housing pot 12. The distance of the outer support surface 122C corresponds to the distance 64 of the outer contact surface 50C of the housing pot 12.

As a whole, the side of the support ring 116 axially facing the connection ring 104 in the region of the support sections 120 is complementary to the side of the collar 48 of the housing pot 12 axially facing away from the housing bottom 32.

The filter medium body 90 comprises an outer filter bellows 134 and an inner filter bellows 136. The filter bellows 134 and 136 each may be comprised of folded filter media, for example, filter nonwoven.

The outer filter bellows 134 has the shape of a hollow truncated cone with elongate oval base surface. The outer filter bellows 134 may be coaxial to the axis 22. The base surface of the outer filter bellows 134 may be located at the side of the main filter element 16 where also the frame element 100 of the skeleton 92 is located. The radially inner wall side of the outer filter bellows 134 extends parallel to its radially outer wall side. The folds of the folded outer filter bellows 134 extend in axial direction, respectively. The folds define the respective wall side.

The radially outer wall surface of the outer filter bellows 134 forms a radially outer exterior wall surface 242 of the filter medium body 90. The radially outer exterior wall surface 242 of the filter medium body 90 comprises, in relation to its course surrounding the axis 22, two curved sections and two straight connection sections. The curved sections may be located at radially opposed sides at the short sides 56. The connection sections may be located at radially opposed sides at the long sides 54. The curved sections may be connected by the straight connection sections.

The radial thickness of the outer filter bellows 134 may be defined by the fold height. The radial thickness of the outer filter bellows 134 correspond approximately to the radial distance of the support ring 116 of the frame element 100 of the skeleton 92 to the radially outer ring 112 and to the radially outer sides of the axial stays 102.

The radially outer circumference and the radially inner circumference of the outer filter bellows 134 decrease respectively in axial direction away from the frame element 100 of the skeleton 92 toward the connection ring 104. The outer filter bellows 134 tapers, viewed in axial direction, from the frame element 100 toward the connection ring 104.

The radially inner wall side of the outer filter bellows 134 may be supported at the respective radially outer sides of the axial stays 102, of the intermediate ring 108, and of the connection arcs 110 of the skeleton 92.

The inner filter bellows 136 has the shape of a hollow truncated cone with elongate oval base surface. The inner filter bellows 136 may be coaxial to the axis 22. The base surface of the inner filter bellows 136 may be located at the side of the main filter element 16 where also the connection ring 104 of the skeleton 92 is located. The radially inner wall side of the inner filter bellows 136 extends parallel to its radially outer wall side. The folds of the folded inner filter bellows 136 extend respectively in axial direction. The folds define the respective wall side.

The radial thickness of the inner filter bellows 136 may be defined by the fold height. The radial thickness of the inner filter bellows 136 corresponds approximately to the radial thickness of the outer filter bellows 134.

The radially outer circumference and the radially inner circumference of the inner filter bellows 136 decrease respectively in axial direction away from the connection ring 104 of the skeleton 92 toward the frame element 100. Viewed in axial direction, the inner filter bellows 136 tapers from the connection ring 104 toward the frame element 100.

The radially outer wall side of the inner filter bellows 136 may be supported at the respective radially inner sides of the axial stays 102, of the intermediate ring 108, of the radially inner ring 106, and of the connection arcs 110 of the skeleton 92.

The circumference of the radially outer wall side of the inner filter bellows 136 in the region of the base surface may be somewhat smaller than the circumference of the radially inner wall side of the outer filter bellows 134 in the region of the cover side. The inner filter bellows 136 may be coaxially arranged in an interior enclosed by the outer filter bellows 134.

At the side of the connection ring 104 of the skeleton 92, the base side of the outer filter bellows 134 may be connected by a circumferentially and radially extending connection fold 138 to the base side of the inner filter bellows 136.

Between the radially outer circumferential side of the inner filter bellows 136 and the radially inner circumferential side of the inner filter bellows 136, the flow spaces 140 are realized. Circumferentially, each of the flow spaces 140 may be delimited by one of two neighboring axial stays 102. Gaseous medium to be purified may flow into the flow spaces 140. From the flow spaces 140, the gaseous medium to be purified may flow functionally parallel through the outer filter bellows 134 from the interior to the exterior in radial direction and through the inner filter bellows 136 from the exterior to the interior in radial direction.

The end member 94 closes off an element interior 42 surrounded by the inner filter bellows 136 at the axial end face which may be facing the frame element 100. The end member 94 may be arranged coaxially to the axis 22. The end member 94 has an elongate oval cross section. The end member 94 may be connected circumferentially in relation to the axis 22 to the radially inner ring 106 of the skeleton 92 and may be supported by the latter. The end member 94 may be made, for example, of elastic material, for example, elastomer.

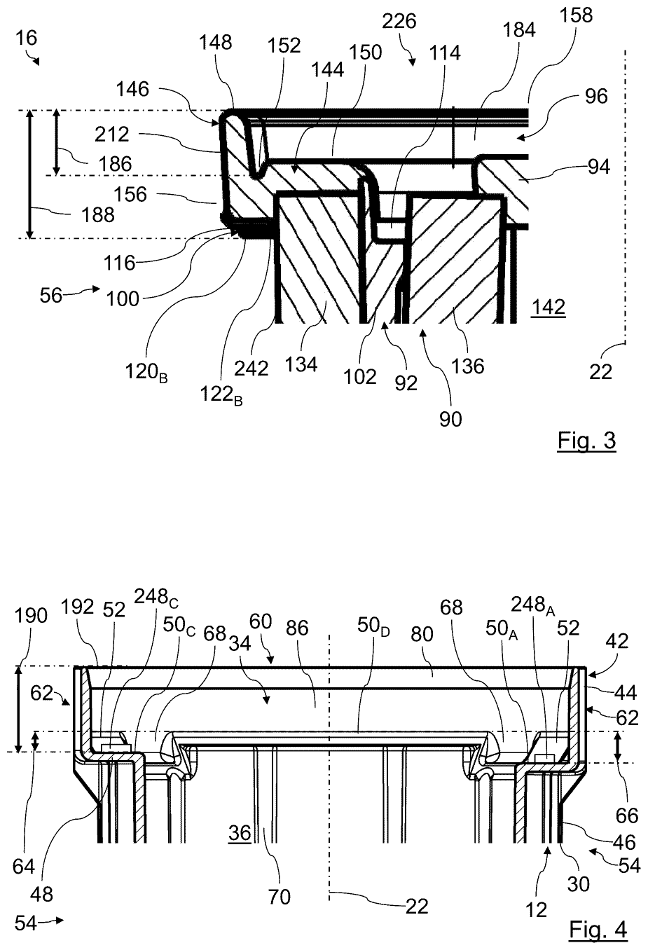

In the following, the seal 96 which is shown in detail in FIG. 3 will be explained in more detail. The seal 96 is annular and has an elongate oval course viewed in axial direction. The seal 96 may be manufactured as one piece from an elastic material, for example, elastomer. The material of the seal 96 may be softer than the material from which the skeleton 92 with the frame element 100 is formed.

The seal 96 comprises a holding section 144 and a seal section 146.

By means of the holding section 144, the seal 96 may be connected to the frame element 100 of the skeleton 92. In this context, the seal 96 with the holding section 144 may be glued or molded to the side of the frame element 100 which is axially facing away from the connection ring 104. The holding section 144 surrounds the radially outer ring 112 of the skeleton 92 and the steps at the ends of the axial stays 102 at their radially outer sides and at the respective radial inner side. The frame element 100 may be embedded thereat in sections by the material of the seal 96.

The holding section 144 may leave exposed the support surfaces 122 at the side of the support ring 116 which is axially facing the connection ring 104.

The holding section 144 extends past the radially outer ring 112 of the skeleton 92 radially outwardly and passes in the region of the radially outer side of the support ring 116 into the seal section 146.

The seal section 146 may be arranged immediately adjacent to, in relation to the axis 22, the radially outer wall surface of the support ring 116 and thus of the frame element 100. In addition, the seal section 146 may be arranged completely radially outside, in relation to the axis 22, of the radially outer wall surface of the filter medium body 90.

A free side 150 of the holding section 144 at the side of the holding section 144 facing away from the frame element of the skeleton 92 extends in a plane perpendicular to the axis 22.

The seal section 146 may be a seal stay. The seal section 146 extends away from the support ring 116 in axial direction. The free end of the seal section 146 extends in a virtual plane perpendicularly to the axis 22. The axial free end 148 of the seal section 146 projects in axial direction past the side 150 of the holding section 144 facing away from the skeleton 92. The radially outer circumference of the seal section 146 in the region of its free end 148 may be somewhat larger than the radially outer circumference of the seal section 146 in the region of the support ring 116. Correspondingly, the radially inner circumference of the seal section 146 in the region of the free end 148 may be larger than the radially inner circumference of the seal section 146 in the region of the transition to the holding section 144. The seal section 146 tapers conically in axial direction from the free end 148 toward the support ring 116.

The seal section 146 may be radially outwardly offset in relation to the radially outer exterior wall surface 242 of the filter medium 90.

When the seal 96 is relaxed, an axial distance 188 between the respective section surface 122 of the frame element 100 of the skeleton 92 and the free end 148 of the seal 96 may be larger than an axial distance 190 between the corresponding contact surface 50 of the collar 48 of the housing pot 12 and a free rim 192 of the collar wall 44.

At the transition of the holding section 144 to the seal section 146, a recess 152 may be located. The recess 152 extends in relation to the axis 22 circumferentially along the radially inner side of the seal section 146 at the side 150 of the holding section 144 facing axially away from the support ring 116.

Viewed in axial direction, the seal section 146 has an elongate oval course. The course of the seal section 146 corresponds to the course of the collar wall 44 of the housing pot 12 and of the frame element 100 of the skeleton 92, viewed in axial direction.

The seal section 146 comprises at the short side 56 a flatly curved section 154 and at the opposed short side 56 a circularly curved section 156. The flatly curved section 154 has a larger radius of curvature than the circularly curved section 156. The flatly curved section 154 and the circularly curved section 156 may be connected at the long sides 54 by a straight connection section 158, respectively.

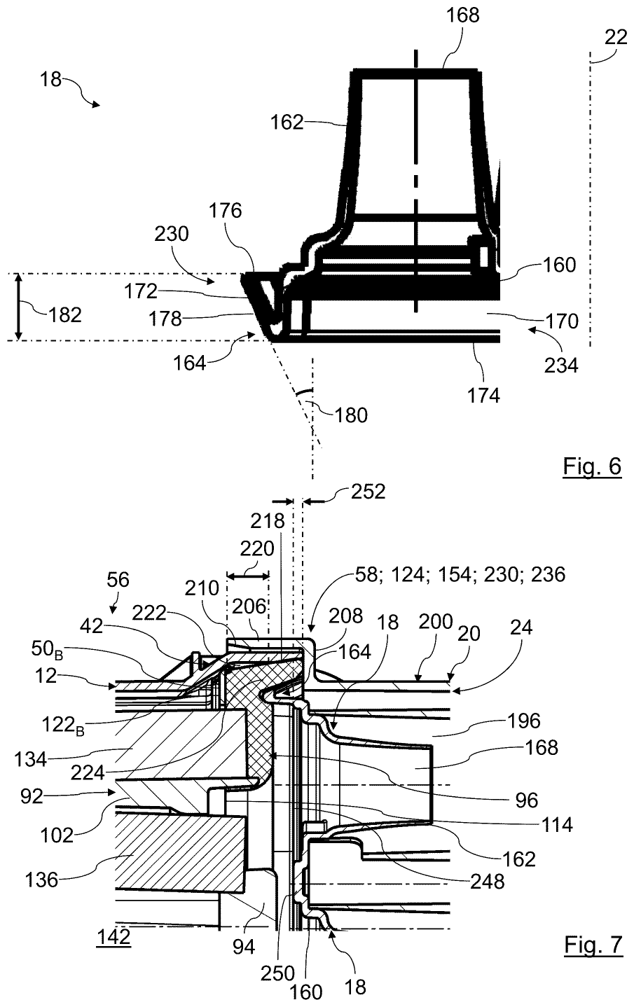

The immersion tube plate 18 will be explained in the following with the aid of FIG. 6 in more detail in which a detail view of the immersion tube plate 18 is shown.

The immersion tube plate 18 may be realized as one piece. The immersion tube plate 18 may be comprised of plastic material, for example, an injection moldable hard plastic material. For example, the immersion tube plate 18 may be produced by an injection molding method.

The immersion tube plate 18 comprises a plate section 160, a plurality of immersion tubes 162, and a rib 164.

The plate section 160 extends in a plane perpendicularly to the axis 22. In the plate section 160, a plurality of immersion tubes 162 may be arranged in distribution. Each one of the immersion tubes 162 may be part of a cyclone separator 166. In FIG. 2, for example, some of the cyclone separators 166 are illustrated. The cyclone separators 166 may be designed as axial cyclones, for example. The immersion tube plate 18 with the immersion tubes 162 forms together with the cyclone housing 20 the cyclone block 24. The cyclone block 24 comprises a plurality of cyclone separators 166.

Each one of the immersion tubes 162 has approximately the shape of a hollow truncated circular cylinder whose axes extend parallel to the axis 22. The base surfaces of the truncated circular cylinders of the immersion tubes 162 may be located at the side of the plate section 160. The immersion tubes 162 taper, viewed in axial direction, away from the plate section 160. The interiors of the immersion tubes 162 serve as inlet openings 168 for the gaseous medium to be purified.

At its radially outer rim, the plate section 160 passes into the rib 164. The rib 164 extends circumferentially contiguously coaxially to the axis 22. The rib 164 has as a whole an approximately V-shaped profile.

One of the legs of the V-shaped rib 164 which in the following is referred to as axial leg 170 may be connected to the rim of the plate section 160. The axial leg 170 may be located at the radially inner side of the rib 164. The axial leg 170 extends, at least in the relaxed state, for example, when the immersion tube plate 18 is not mounted, axially approximately parallel to the axis 22 and circumferentially.

The other leg of the “V” which in the following is referred to as ramp leg 172 may be connected at the side of the axial leg 170, axially facing away from the plate section 160, to the latter. The connection rim of the axial leg 170 to the ramp leg 172, i.e., the closed side of the “V”, is referred to in the following as rib rim 174. The ramp leg 172 may be located at the radially outer side of the rib 164. The ramp leg 172 extends radially outwardly at a slant to the axis 22 away from the rib rim 174 at the side which may be axially facing the plate section 160. The free end of the ramp leg 172 is referred to as free rim 176.

The radially outer side of the ramp leg 172 forms a contact surface 178. When the filter device 10 is assembled, the contact surface 178 may be positioned at the seal section 146 of the seal 96 of the main filter element 16, as will be explained below. The contact surface 178 extends at a slant to the axis 22 and circumferentially. The contact surface 178 extends at an acute angle 180 in relation to the axis 22. The angle 180 may amount to approximately between 30° and 45°, for example.

An axial distance 182 between the free rim 176 and the rib rim 174 may be approximately of the same size as an axial distance between the rib rim 174 and the plate section 160.

Viewed in axial direction, the rib 164 has an elongate oval course. The course of the rib 164 corresponds to the course of the collar wall 44 of the housing pot 12, of the frame element 100 of the skeleton 92, and of the seal section 146 of the seal 96, viewed in axial direction.

The rib 164 comprises at the short side 56 a flatly curved section 230 and at the opposed short side 56 a circularly curved section 232 shown in FIG. 2. The flatly curved section 230 has a larger radius of curvature than the circularly curved section 232. The flatly curved section 230 and the circularly curved section 232 may be connected at the long sides 54 by a straight connection section 234, respectively.

The circumference of the rib rim 174 corresponds to the circumference of the recess 152 of the seal 96. The acute angle 180 of the contact surface 178 may be larger than an angle between a radially inner seal surface 184 of the seal section 146 of the seal 96 and the axis 22 when the seal 96 is relaxed, for example, in an unmounted state. The axial distance 182 between the rib rim 174 and the free rim 176 of the rib 164 corresponds approximately to an axial distance 186 at the seal 96 between the base of the recess 152 and the free end 148 of the seal section 146.

The cyclone housing 20 will be explained in more detail in the following with the aid of FIGS. 1, 2, and 7.

The cyclone housing 20 comprises a fastening frame 194, a plurality of separation chambers 196, and a particle discharge device 198 and a total of four clamping clips 78.

The separation chambers 196 may be located in a main part 200 of the cyclone housing 20. Each one of the separation chambers 196 may be correlated to one of the immersion tubes 162 of the immersion tube plate 18. The immersion tubes 162 with the corresponding separation chamber 196 form one of the cyclone separators 166, respectively. The separation chambers 196 each have an approximately circular cylindrical shape. The axes of the separation chambers 196 extend parallel to the axis 22. The axes of the separation chambers 196 extend coaxially to axes of the corresponding immersion tubes 162 when the filter device 10 is assembled.

The particle discharge device 198 may be arranged at a radially outer side of the main part 200. The separation chambers 196 may be connected in fluid communication to the particle discharge device 198 in a manner not of interest in this context. In this manner, the particles, for example, dust particles, which have been separated in the respective cyclone separator 166 from the gaseous medium to be purified may reach the particle discharge device 198.

The particle discharge device 198 has a discharge opening 202. The discharge opening 202 may be closed during regular operation of the filter device 10. The discharge opening 202 may be opened for discharging the particles collected in the particle discharge device 198. In the operative mounting orientation of the filter device 10 illustrated in FIG. 1, for example, the particle discharge device 198 may be arranged spatially at the bottom at the cyclone housing 20. The discharge opening 202 may be thus oriented spatially downwardly.

The fastening frame 194 may be located at an axial end face of the main part 200. At the side of the main part 200 axially arranged opposite the fastening frame 194, each one of the separation chambers 196 comprises an inlet opening 204 for the gaseous medium to be purified. At the side which is axially facing the fastening frame 194, each one of the separation chambers 196 comprises an opening for the corresponding immersion tube 162.

The fastening frame 194 comprises an outer frame wall 206 which may be connected by a collar 208 to the main part 200.

The outer frame wall 206 and the collar 208 extend circumferentially contiguously around the axis 22.

The collar 208 extends in radial direction away from the main part 200 radially outwardly. The outer frame wall 206 extends in axial direction away from the collar 208 away from the main part 200.

In the region of its free rim facing axially away from the main part 200, the outer frame wall 206 comprises a guide ramp 210 at the radially inner circumferential side. In the region of the guide ramp 210, the radially inner circumference of the outer frame wall 206 becomes larger in axial direction away from the main part 200 toward the free rim.

The circumferential course of the outer frame wall 206 around the axis 22 corresponds to the circumferential course of the collar 42 of the housing pot 12.

Viewed in axial direction, the outer frame wall 206 has an elongate oval course. The course of the outer frame wall 206 corresponds to the course of the collar wall 44 of the housing pot 12, of the frame element 100 of the skeleton 92, of the seal section 146 of the seal 96, and of the rib 164 of the immersion tube plate 18, viewed in axial direction.

The outer frame wall 206 comprises at the short side 56 a flatly curved section 236 and at the opposed short side 56 a circularly curved section 238. The flatly curved section 236 has a larger radius of curvature than the circularly curved section 238. The flatly curved section 236 and the circularly curved section 238 may be connected at the long sides 54 by a straight connection section, respectively, not illustrated.

The radially inner circumference of the outer frame wall 206 in the region axially between the guide ramp 210 and the main part 200 may be somewhat larger than the radially outer circumference of the collar 42 of the housing pot 12.

The radially outer side of the main part 200 has an elongate oval course, viewed in axial direction. In this context, the curved sections at the short sides 56 have the same radius of curvature. Thus, the elongate oval course of the main part 200 differs from the elongate oval course of the outer frame wall 206. The radially outer circumference of the main part 200 corresponds approximately to the radially outer circumference of the main wall section 46 of the housing pot 12.

Two of the clamping clips 78 may be located at the side of the flatly curved section 236 in the region of the transition to the corresponding straight connection section, respectively. The two other clamping clips 78 may be located at the side of the circularly curved section 238 in the region of the transition to the corresponding straight connection section, respectively.

The clamping clips 78 engage respectively in the region of the outer side of the collar 208 facing away axially from the outer frame wall 206. The clamping clips 78 extend past the free rim of the outer frame wall 206. The clamping clips 78 may be spring clips, for example.

A method for assembly of the filter device 10 will be explained in the following.

First, the immersion tube plate 18 may be connected to the cyclone housing 20. For this purpose, the immersion tube plate 18 with the immersion tubes 162 leading may be advanced in axial direction into the fastening frame 194. In this context, it may be required to rotate the immersion tube plate 18 and the cyclone housing 20 relative to each other around the axis 22 such that the flatly curved section 236 of the outer frame wall 206 coincides with the flatly curved section 230 of the rib 164, on the one hand, and the circularly curved section of the fastening frame 194 and the circularly curved section 232 of the rib 164 coincide.

Upon assembly, the immersion tubes 162 may be arranged in one of the separation chambers 196, respectively. Subsequently, the immersion tube plate 18 may be fixed with screws 28 to the cyclone housing 20. In case of a future exchange of the main filter element 16 and/or of the after filter element 14 from the filter device 10, the immersion tube plate 18 may remain at the cyclone housing 20. In this way, the entire cyclone block 24 may be separated from the housing pot 12.

The after filter element 14, with its side facing axially away from the seal 88 leading, may be inserted in axial direction through the service opening 34 into the housing pot 12. In this context, it may be required to rotate the housing pot 12 and the after filter element 14 relative to each other around the axis 22 such that the long sides 54 of the after filter element 14 coincide with the long sides 54 of the housing pot 12 and the short sides 56 of the after filter element 14 with the short sides 56 of the housing pot 12. The after filter element 14 may be placed in the stepped section of the housing wall 30 axially adjacent to the housing bottom 32.

Subsequently, the main filter element 16, with its side axially facing away from the seal 96 leading, may be inserted in axial direction through the service opening 34 into the filter element interior 36 of the housing pot 12. For this purpose, it may be required to rotate the housing pot 12 and the main filter element 16 relative to each other in relation to the axis 22 such that the short side 56 of the main filter element 16 with the flatly curved section 124 of the frame element 100 of the skeleton 92 and the flatly curved section 154 of the seal 96 coincides with the short side 56 of the housing pot 12 with the flatly curved section 58 of the collar wall 44.

In this relative rotational position, the elevations 248A and 248C on the part of the housing pot 12 also coincide with the respective corresponding cutouts 250A and 250C on the part of the frame element 100 of the main filter element 16.

The main filter element 16 may be pushed in axial direction so far into the housing pot 12 that the support surfaces 122 of the skeleton 92 contact axially the corresponding contact surfaces 50 of the collar 42.

In the mounted state in which the main filter element 16 may be arranged in the filter element receiving space 38 of the housing pot 12, the first elevation 248A on the first outer axial contact surface 50A of the radially projecting collar 42 of the housing pot 12 engages the corresponding first cutout 250A of the first outer support section 120A of the main filter element 16. The second elevation 248C on the second outer axial contact surface 50C of the radially projecting collar 42 of the housing pot 12 engages the corresponding second cutout 250C of the second outer support section 120C of the main filter element 16.

The arrangement of the elevations 248A and 248C on the outer axial contact surfaces 50A and 50C of the radially projecting collar 42 of the housing part 12 and of the corresponding cutouts 250A and 250C of the outer support sections 120A and 120C of the main filter element 16 may be such that an unequivocal installation position of the main filter element 16 in the housing part 12 results.

The interaction of the elevations 248A and 248C and of the corresponding cutouts 250A and 250C prevents that the main filter element 16 may be mounted in a different installation position. Furthermore, it is prevented that a filter element which does not have the required cutouts 250A and 250C may be installed. In this way, as a whole the risk of wrong mounting in relation to the wrong installation of the main filter element 16 as well as in relation to the installation of a wrong, i.e., unsuitable, main filter element 16 may be reduced.

Furthermore, the radially outer wall surface 212 of the seal section 146 may be spaced apart in radial direction in relation to the interior wall surface 86 of the collar wall 44 of the collar 42 of the housing pot 12. Between the radially outer wall surface 212 of the seal 96 and the interior wall surface 86 of the collar 42 there remains a radial gap which is not illustrated in the drawing figures. The radial gap extends in relation to the axis 22 circumferentially and in axial direction across the entire axial expansion of the interior wall surface 86. In the preliminary mounting state, the free end 148 of the seal section 146 projects in axial direction past the free rim 192 of the collar wall 44 of the housing pot 12.

Subsequently, the cyclone block 24 with the immersion tube plate 18 leading may be pushed in axial direction onto the collar 42 of the housing pot 12. In this context, it may be required to rotate the housing pot 12 and the cyclone block 24 around the axis 22 such that the short side 56 of the collar wall 44 with the flatly curved section 58 coincides with the short side 56 of the outer frame wall 206 of the cyclone housing 20 with the flatly curved section 236 and, correspondingly, the short side 56 of the collar wall 44 with the circularly curved section 60 coincides with the short side 56 of the outer frame wall 206 with the circularly curved section 238.

Upon axially pushing on, first the free rim 192 of the collar wall 44 may be guided along the radially inner side of the guide ramp 210 of the outer frame wall 206 of the cyclone housing 20 and centered in this way within the fastening frame 94. Upon further insertion, the radially outer side of the ramp leg 172 of the rib 164 of the immersion tube plate 18 glides along the radially inner seal surface 184 of the seal 96. Because the frame leg 172 has a larger slant angle in relation to the axis 22 than the radially inner seal surface 184 of the seal 96, the rib 164 pushes the seal section 146 radially outwardly against the interior wall surface 86.

Upon further insertion, the rib rim 174 of the rib 164 may be immersed into the recess 152 of the seal 96. Furthermore, the collar 208 of the cyclone housing 20 presses in axial direction against the free end 148 of the seal section 146. In this way, the seal section 146 may be compressed in axial direction and deformed. The material of the seal section 146 yields to the axial compression in radial direction. In this way, an additional increase of a radially acting contact pressure may be created with which the seal section 146 may be pressed against the interior wall surface 86 of the collar wall 44.

The free ends of the clamping clips 78 may be hooked behind the respective engagement sections 76, as shown in FIG. 1. Subsequently, the clamping clips 78 may be clamped. In this way, the cyclone block 24 may be pushed strongly in axial direction against the collar 42. The axial movement may be limited in that the free rim 192 of the collar wall 44 of the housing pot 12 may be supported in axial direction at the collar 208 of the cyclone housing 20, as illustrated in FIGS. 2 and 7.

In the finish-mounted position illustrated in FIGS. 1, 2 and 7, the radially outer wall surface 212 of the seal 96 seal-tightly rests in a contact section 218 at the interior wall surface 86 of the collar 42 of the housing pot 12. The contact section 218 begins at an axial distance 220 in relation to the frame element 100 of the skeleton 92, for example in relation to the respective contact surface 50, and extends in an axial direction to the free rim 192 of the collar wall 44. Between the frame element 100 and the beginning of the contact section 218, there remains a residual gap 222 between the radially outer circumferential side of the seal section 146 and the interior wall surface 86 of the collar wall 44. The residual gap 222 extends circumferentially contiguously and in axial direction. The residual gap 222 has a wedge-shaped profile which decreases toward the contact section 218 in axial direction.

Each immersion tube 162 comprises an outflow end 248 at its side facing the inflow side 226 of the filter element 16. The outflow end 248 may be surrounded by an immersion tube rim section 250. The immersion tube rim sections 250 of neighboring immersion tubes 162 pass into each other. The immersion tube rim sections 250 may be formed in the plate section 160 of the immersion tube plate 18.

The immersion tube rim sections 250 are located, when the filter device 10 is assembled, as illustrated in FIG. 7, for example, at an axial distance 252 in relation to the free end 148 of the circumferential seal 96 radially inside of the seal section 146.

The outflow ends 248 of the immersion tubes 162 may be located, viewed axially, beyond the inflow-side axial free end 148 of the circumferential seal 96. The immersion tube rim sections 250 surrounding the outflow ends 248 and thus also the outflow ends 248 of the immersion tubes 162, dip behind the free end 148 of the circumferential seal 96 and thus behind the inflow-side end of the main filter element 16, viewed axially.

Between the immersion tube plate 18 and the housing pot 12, a seal chamber 224 may be realized in the finish-mounted state in which the seal section 146 of the seal 96 and a part of the holding section 144 may be arranged. The seal chamber 224 may be delimited radially inwardly by the rib 164 of the immersion tube plate 18, radially outwardly by the interior wall surface 86 of the collar wall 44 of the housing pot 12, and axially by the collar 208 of the cyclone housing 20 connected to the immersion tube plate 18.

For mounting, for example, at a machine which requires the gaseous medium purified by the filter device 10, the filter device 10 may be mounted with the short side 56, at which the particle discharge device 198 of the cyclone block 24 may be arranged, spatially at the bottom. In this context, the axis 22 may be substantially horizontally arranged.

In operation of the filter device 10, the gaseous medium to be purified, for example, air, may be sucked in through the inlet opening 204 of the cyclone separators 166. The flow of the gaseous medium within the filter device 10 is illustrated in FIG. 2 by curved arrows.

A coarse separation of particles takes place in the cyclone separators 166. The separated particles sink, following the force of gravity, downwardly to the particle discharge device 198 where they are collected. The discharge opening 202 of the particle discharge device 198 is opened as needed or when servicing and the particle discharge device 198 may be emptied.

The pre-purified gaseous medium passes through the inlet openings 168 of the immersion tubes 162 to the inflow side 226 of the main filter element 16. The inflow side 226 may be located at the side of the main filter element 16 at which also the seal 96 is located.

The gaseous medium to be purified flows into the flow spaces 140 between the outer filter bellows 134 and the inner filter bellows 136. In doing so, the gaseous medium may be distributed circumferentially by flowing through the connection openings 114. From the flow spaces 140, the gaseous medium to be purified flows through the outer filter bellows 134 in radial direction from the interior to the exterior, is further purified by it, and reaches an annular space which surrounds the main filter element 16 radially outwardly. Functionally in parallel, the gaseous medium to be purified flows through the inner filter bellows 136 in radial direction from the exterior to the interior, is purified further by it, and reaches the element interior 142.

The gaseous medium from the annular space purified in the second stage and the gaseous medium from the element interior 42 purified in the second stage reaches the outflow side 228 of the main filter element 16. The outflow side 228 of the main filter element 16 may be located at the side which is axially facing away from the inflow side 226.

From the outflow side 228, the gaseous medium purified in the second stage flows into the after filter element 14 and is further purified by the latter.

The gaseous medium which has been purified in total in three stages exits the filter device 10 through the outlet opening 40 of the filter housing 26. From there, the purified gaseous medium is sucked in by corresponding components of the machine.

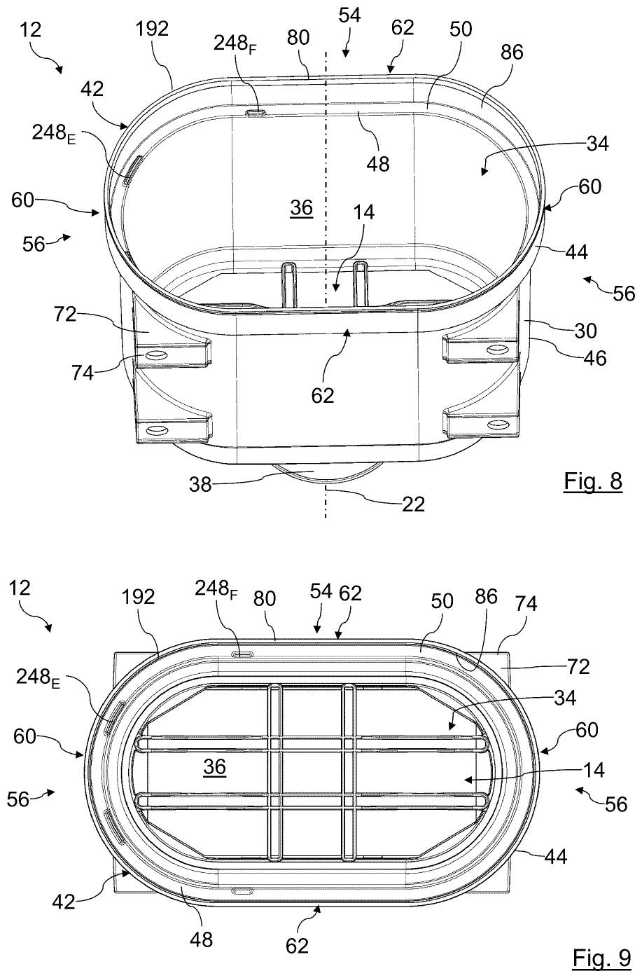

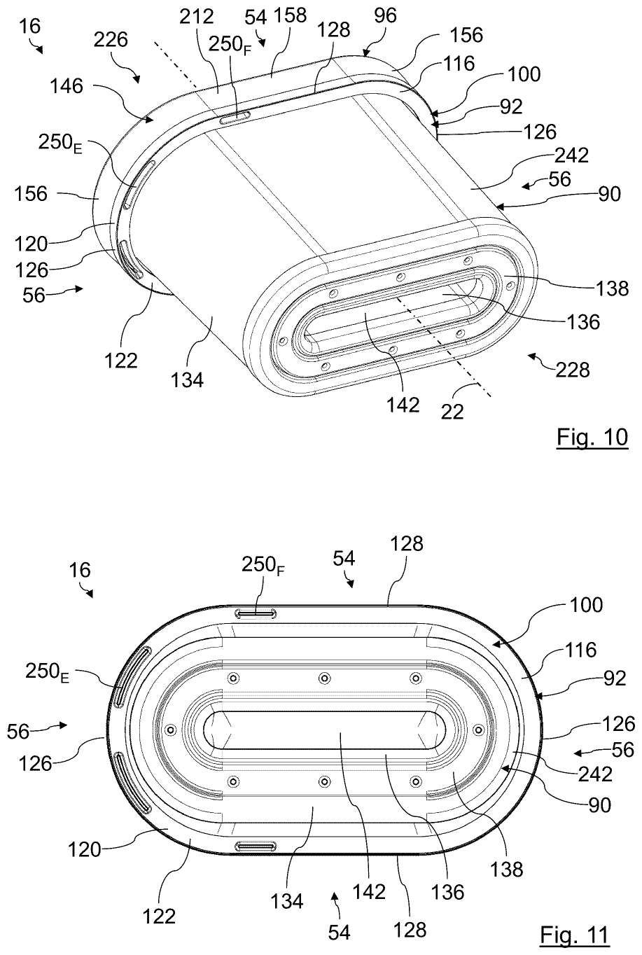

In FIGS. 8 to 11, a second embodiment of the filter device is illustrated. Those elements which are similar to those of the first embodiment of FIGS. 1 through 7 are provided with the same reference characters. The second embodiment differs from the first embodiment, for example, in that the collar 42 of the housing part 12, the frame element 100 of the skeleton 92, the seal 96, the rib 164 of the immersion tube plate 18, and the fastening frame 194 of the cyclone housing 20 may be circularly curved at both short sides 56.

Furthermore, the collar 42 of the housing pot 12 may comprise only a single circumferentially contiguous contact surface 50. In an embodiment, no ramp surfaces are provided on the long sides 54. The contact surface 50 extends at an axial height in a plane perpendicularly to the axis 22.

Furthermore, the housing part 12 may have no grooves 70.

The frame element 100 of the skeleton 92 of the main filter element 16 may comprise only a circumferentially contiguous support section 120 with a circumferentially contiguous support surface 122. The support surface 122 extends at an axial height in a plane perpendicularly to the axis 22.

At the axial contact surface 50, two elevations 248E may be arranged in one of the curved sections 60 of the radially projecting collar 42 of the housing pot 12. In the straight connection sections 62 of the radially projecting collar 42 of the housing pot 12, one elevation 248F may be arranged, respectively.

The two elevations 248E in the curved section 60 of the axial contact surface 50 of the housing pot 12 may be identical in regard to their height, their extension in circumferential direction and/or transverse to the circumferential direction.

Also, the two elevations 248F in the straight connection sections 62 of the axial contact surface 50 of the housing pot 12 may be identical in respect to their height, their extension in circumferential direction and/or transverse to the circumferential direction.

The two elevation 248E in the curved section 60 of the axial contact surface 50 and the two elevations 248F in the straight connection sections 62 of the axial contact surface 50 differ for example in regard to their extension in circumferential direction and thus may be different.

Two cutouts 250E corresponding to the elevations 248E in the curved section 60 of the radially projecting collar 42 of the housing pot 12 may be arranged in the one curved section 126 of the support section 120 of the frame element 100 of the main filter element 16. In the straight sections 128 of the support section 120 of the frame element 100 of the main filter element 16, a cutout 250F corresponding to the elevations 248F in the straight connection sections 62 may be arranged, respectively.

The cutouts 250E and 250F may be configured as a closed pocket, respectively, in analogy to the cutouts 250A and 250C in the first embodiment. The cutouts 250E and 250F each have a contiguous boundary wall.

The two cutouts 250E in the curved section 126 of the support section 120 of the frame element 100 of the main filter element 16 may be identical in respect to their height, their extension in circumferential direction and/or transverse to the circumferential direction.

Likewise, the two cutouts 250F in the straight sections 128 of the support section 120 of the main filter element 16 may be identical in their height, their extension in circumferential direction and/or transverse to the circumferential direction.

The two cutouts 250E in the curved section 126 of the support section 120 and the two cutouts 250F in the straight sections 128 of the support section 120 differ in respect to their extension in circumferential direction and may be therefore different.

The inner dimensions of the cutouts 250E and 250F of the frame element 100 of the main filter element 16 may be as large as the outer dimensions of the elevations 248E or 248F of the housing pot 12 corresponding to the respective cutouts 250E or 250F. The cutouts 250E and 250F of the frame element 100 of the main filter element 16 and the correlated corresponding elevations 248E and 248F of the housing pot 12 may be complementary.

The support section 120 of the main filter element 16 with the cutouts 250E and 250F has no rotational symmetry in relation to the axis 22.

In the mounted state in which the main filter element 16 is mounted in the housing pot 12, the elevations 248E and 248F and the corresponding cutouts 250E and 250F may be mirror-symmetrical configured in relation to a virtual plane which extends perpendicularly to the virtual axis 22.

That which is claimed is:

1. A filter device for a gaseous medium, the filter device comprising:
a filter housing comprising at least one inlet opening for the gaseous medium to be purified and at least one outlet opening for the purified gaseous medium;
at least one filter element comprising at least one filter medium body, wherein the at least one filter element is arranged in the filter housing between the at least one inlet opening and the at least one outlet opening in such a way that the at least one filter element separates a raw side correlated with the at least one inlet opening from a clean side correlated with the at least one outlet opening;
wherein the filter housing comprises a first housing part comprising a service opening and at least one filter element receiving space, wherein the at least one filter element is arranged in the at least one filter element receiving space, and wherein the at least one outlet opening is arranged at the first housing part;
wherein the filter housing comprises a second housing part comprising one or more parts of at least one cyclone separator, wherein the at least one inlet opening is arranged at the second housing part, and wherein the second housing part closes off the service opening of the first housing part;
wherein the first housing part and the second housing part are releasably connected to each other and separable from each other in order to be able to remove the at least one filter element through the service opening;
wherein the first housing part comprises a radially projecting collar at least partially circumferentially extending around a virtual axis in a circumferential direction, wherein the radially projecting collar comprises, in relation to the virtual axis, at least one axial contact surface;
wherein the at least one filter element comprises at least one support section, projecting in relation to the virtual axis radially past the at least one filter medium body and circumferentially extending at least partially around the virtual axis in the circumferential direction, wherein the at least one support section is supported on the at least one axial contact surface of the radially projecting collar;
wherein the at least one axial contact surface of the radially projecting collar comprises one or more elevations;
wherein the at least one support section of the at least one filter element comprises one or more cutouts corresponding to the one or more elevations and engaging the one or more elevations;
wherein an arrangement of the one or more elevations and of the one or more cutouts is such that an unequivocal installation position of the at least one filter element in the first housing part results.

2. The filter device according to claim 1, wherein the at least one axial contact surface of the radially projecting collar comprises a plurality of the one or more elevations and/or the at least one support section of the at least one filter element comprises a plurality of the one or more cutouts.

3. The filter device according to claim 1, wherein the at least one axial contact surface of the radially projecting collar comprising the one or more elevations comprises no rotational symmetry in relation to the virtual axis and/or the at least one support section of the at least one filter element comprising the one or more cutouts comprises no rotational symmetry in relation to the virtual axis.

4. The filter device according to claim 1, wherein inner dimensions of the one or more cutouts are at least as large as outer dimensions of the one or more elevations and/or the one or more cutouts and the one or more elevations are complementary.

5. The filter device according to claim 1, wherein the one or more elevations include at least two elevations which differ from each other in regard to an extension thereof in the circumferential direction, a height thereof and/or an extension thereof transverse to the circumferential direction, and/or the one or more cutouts include at least two cutouts which differ from each other in regard to an extension thereof in the circumferential direction, a height thereof and/or an extension thereof transverse to the circumferential direction.

6. The filter device according to claim 1, wherein the one or more elevations include at least two elevations which differ from each other in regard to a shape thereof, a dimension thereof and/or an orientation thereof and wherein the one or more cutouts include at least two cutouts which differ from each other in relation to a shape thereof, a dimension thereof and/or an orientation thereof.

7. The filter device according to claim 1, wherein the at least one filter element comprises an inflow side facing the second housing part, wherein the at least one filter element further comprises a seal arranged at the inflow side and extending circumferentially around the virtual axis in the circumferential direction, wherein the seal comprises at least one seal section at least partially radially sealingly acting in relation to the virtual axis and extending circumferentially around the virtual axis in the circumferential direction, wherein, in relation to the virtual axis, a radially outer circumferential side of the seal section seal-tightly rests against a radially inner interior wall surface of the first housing part, wherein the second housing part comprises a rib projecting away from the second housing with at least one directional component in an axial direction in relation to the virtual axis and at least partially circumferentially extending around the virtual axis in the circumferential direction, wherein the rib applies a contact pressure on the seal and presses the at least one seal section against the radially inner interior wall surface of the first housing part.

8. The filter device according to claim 1, wherein the at least one filter element comprises at least one frame element connected to the at least one filter medium body and extending at least partially circumferentially around the filter medium body in the circumferential direction, wherein the at least one frame element comprises at least one exposed section and the at least one exposed section at least partially forms the at least one support section of the at least one filter element.

9. The filter device according to claim 8, wherein the at least one filter element comprises at least one circumferentially extending seal, wherein the at least one circumferentially extending seal comprises an axial end facing away from the second housing part and delimited by the at least one frame element.

10. The filter device according to claim 9, wherein the at least one frame element is embedded at least in section in a material of the at least one circumferentially extending seal.

11. The filter device according to claim 8, wherein the one or more cutouts are formed in the at least one circumferentially extending frame element and/or the one or more cutouts comprise a contiguous boundary wall and are configured as a closed pocket.

12. The filter device according to claim 8, wherein the at least one frame element, beginning at the at least one exposed section, extends at least in sections in an axial direction toward an inflow side of the at least one filter element and/or radially inwardly in relation to the virtual axis.

13. The filter device according to claim 1, wherein the second housing part comprises a rib projecting away from the second housing part toward the first housing part, wherein the at least one filter element comprises a seal section, wherein the seal section extends circumferentially in the circumferential direction and acts at least partially radially sealingly in relation to the virtual axis, wherein the rib supports the seal section at a radially inner circumferential side thereof.

14. The filter device according to claim 13, wherein a contact surface of the rib facing the radially inner circumferential side of the seal section is positioned at an acute angle in relation to the virtual axis.

15. The filter device according to claim 1, wherein the second housing part comprises a rib projecting away from the second housing part toward the first housing part, wherein the at least one filter element comprises a seal extending circumferentially around the virtual axis in the circumferential direction, wherein the rib contacts the seal with a directional component of a contact pressure acting axially in relation to the virtual axis.

16. The filter device according to claim 15, wherein the seal comprises at least one seal section, wherein the rib is configured at least in sections in a ramp shape.

17. The filter device according to claim 1, wherein the at least one filter element comprises a seal comprising at least one at least partially radially sealingly acting circumferentially extending seal section, wherein the at least one at least partially radially sealingly acting circumferentially extending seal section is offset, at least in sections, radially outwardly in relation to a radially outer exterior wall surface of the at least one filter medium body in relation to the virtual axis, and/or the at least one at least partially radially sealingly acting circumferentially extending seal section axially projects at least in sections past an inflow side of the at least one filter medium body.

18. The filter device according to claim 1, further comprising a cyclone block comprising a plurality of the at least one cyclone separators, wherein the one or more parts of the at least one cyclone separator include an immersion tube, wherein the cyclone block comprises an immersion tube plate comprising a plurality of the immersion tubes, wherein the immersion tube plate is the second housing part, wherein the immersion tube plate comprises a circumferential rib and/or the at least one inlet opening is arranged at one of the plurality of immersion tubes.

19. The filter device according to claim 1, wherein the second housing part comprises parts of a cyclone block comprising a plurality of the at least one cyclone separator.

20. A filter element for a filter device for gaseous fluid, wherein the filter device comprises a filter housing comprising at least one inlet opening and at least one outlet opening, wherein the filter element is receivable in the filter housing between the at least one inlet opening and the at least one outlet opening in order to separate a raw side correlated with the at least one inlet opening from a clean side correlated with the at least one outlet opening,
wherein the filter housing comprises a first housing part comprising a service opening and further comprises at least one filter element receiving space configured to receive the filter element, wherein the at least one outlet opening is arranged at the first housing part; wherein the filter housing comprises a second housing part comprising one or more parts of at least one cyclone separator, wherein the at least one inlet opening is arranged at the second housing part, and wherein the second housing part closes off the service opening of the first housing part; wherein the first housing part and the second housing part are releasably connected to each other and separable from each other in order to be able to remove the filter element through the service opening; wherein the first housing part comprises a radially projecting collar at least partially circumferentially extending around a virtual axis in a circumferential direction, wherein the radially projecting collar comprises, in relation to the virtual axis, at least one axial contact surface, wherein the at least one axial contact surface comprises one or more elevations; the filter element comprising:
at least one filter medium body;
at least one support section, projecting in relation to the virtual axis radially past the at least one filter medium body and circumferentially extending at least partially around the virtual axis in the circumferential direction, wherein the at least one support section is configured to be supported on the at least one axial contact surface of the radially projecting collar of the first housing part;
wherein the at least one support section comprises one or more cutouts corresponding to the one or more elevations of the at least one axial contact surface of the radially projecting collar of the first housing part and configured to engage the one or more elevations of the at least one axial contact surface of the radially projecting collar of the first housing part;
wherein an arrangement of the one or more cutouts is such that, in a mounted state of the filter element in the first housing part in which the one or more cutouts of the at least one support section engage the one or more elevations of the at least one axial contact surface of the radially projecting collar of the first housing part, an unequivocal installation position of the filter element in the first housing part results.
